(19) United States
(12) Patent Application Publication
(10) Pub. No.: US 2009/0158190 A1
(43) Pub. Date: Jun. 18, 2009

(54) COMPUTING APPARATUS INCLUDING A PERSONAL WEB AND APPLICATION ASSISTANT

(75) Inventor: Timothy B. Higginson, Highland Park, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Yuvee, Inc., Highland Park, IL (US)

(21) Appl. No.: 12/334,984

(22) Filed: Dec. 15, 2008

Related U.S. Application Data
(60) Provisional application No. 61/013,563, filed on Dec. 13, 2007.

(51) Int. Cl. G06F 3/048

(52) U.S. Cl. 715/773

(57) ABSTRACT

A computing device is configured to include a computer-readable medium having computer-executable instructions for a personal Web and application assistant program.

### CROSS-REFERENCE TO RELATED APPLICATION

This application claims the priority benefit of Higginson, U.S. patent application Ser. No. 61/013,563, filed on Dec. 13, 2007, the contents of which are incorporated herein by reference in their entirety, including the contents of any references contained therein.

### INCORPORATION BY REFERENCE

This application incorporates by reference in its entirety the disclosure of Higginson U.S. Pat. No. 6,703,963 for a “Universal Keyboard” and U.S. Pat. No. 7,250,898 B2 for a “Universal Keyboard”. The disclosure in the first aforementioned patent includes a description of a multi-function, multi-domain level keypad/keyboard within which the physical and functional features described herein are advantageously incorporated. The disclosure in the second aforementioned patent includes a description of a multi-function input device within which the physical and functional features described herein are advantageously incorporated.

### AREA OF THE INVENTION

The present invention generally relates to computing devices including a combined and customizable website and application organizer, player and revenue system for personal computers, laptops, handheld communications devices and other contexts.

### BACKGROUND

To date, the two primary computing system user interfaces for applications on desktop personal computers and laptops has been the so-called “desktop” and a web “browser”.

The “desktop” is used to organize and run applications, including the browser. The desktop generally consists of a graphical user interface consisting of (1) icons that represent shortcuts for the user to run applications' executable files, and (2) some form of task bars (at the top, bottom or sides of the desktop user interface) that have menus in which, in some form of list structure, all applications can be found and selected and run.

The “browser” is used to access and organize websites and other Internet information, services and applications. The browser generally consists of a screen with task bars at the top (at least) of the screen and an area under the task bars to display the Internet content chosen by the user. A user accesses web content generally by (1) entering a URL in a box in a task bar at the top; (2) also by selecting from “bookmarked” or “favorite” sites in a pull-down menu from the browser task bar; (3) by searching for content using an on-line search engine (e.g., Google, Yahoo, Ask, Dogpile, etc.); and/or (4) by using websites that allow more sophisticated forms of bookmarking (e.g., del.icio.us, Digg, Fark, Newsvine, Stumbleupon, etc.).

Users must therefore learn at least two entirely separate user interfaces (the “desktop” and the “browser”) in order to access and use the applications and data files resident on their devices, and to access and use the applications and information resident on the Web. Further, each of these two user interface systems are designed for large screen devices, and inherently require large screens to be used effectively because, for instance, of the number of icons, size and number of task bars and size and number of pull-down menus. Each requires allocating significant areas of the display to task bars, multiple icons and other information. For small screen devices, the size of the display alone makes these user interface systems problematic. These user interfaces are designed to be used in conjunction with a separate mouse device (with cursor control and right and left click keys) and a physical keyboard (with easy access to a full range of letters, symbols (e.g., “@” for email addresses and “/” for many URLs), etc.).

### SUMMARY OF INVENTION/DISCLOSURE

The aforementioned shortcomings of computing devices (e.g., personal computers and personal hand held computing devices—including cellular phones and other wireless handheld computing devices), including two separate user interfaces (one for applications and one for the Web)—each designed for large screen devices—is addressed by a personal Web and application assistant program comprising computer executable instructions contained on computer readable media on the computing devices and executed to provide a single graphical user interface that incorporates a single, consistent paradigm for accessing and using both application programs and websites.

In the disclosed embodiment, the personal Web and application assistant program is itself an application program containing a graphical display interface that generally sits on top of both a browser application window and a computer operating system's desktop interface through which a user opens/accesses a set of application programs installed on the computing device, and gives the user control of both the browser program and the installed application programs. The screen area occupied by the personal Web and application assistant user interface is relatively small, and consists of a moveable (and re-sizeable) window that can be shifted off the screen or around the screen, or minimized.

In a computing device is described herein for providing access to a variety of applications and resources. The computing device includes a display, and a computer-readable medium comprising computer-executable instructions for a personal web and application assistant (PWAA) program. The PWAA program is executable on the computing device to support a number of support tasks aiding a user in accessing the Internet via a browser as well as enabling quick access to application programs installed on the computing device. The support functionality includes providing a PWAA interface on the display, wherein the PWAA interface provides button controls and associated programmable displays for (1) organizing, accessing and using application programs on the computing device, and (2) organizing, accessing and using websites. The application programs and websites are organized on the PWAA interface by categories selectable by: first selecting from a first set of virtual keys associated with a highest level of organization of applications programs and websites, second selecting from a second set of virtual keys to assign particular programmed instructions to individual launch keys in a third set of virtual keys.

### BRIEF DESCRIPTION OF THE DRAWINGS

While the claims set forth the features of the present invention with particularity, the invention, together with its objects and advantages, may be best understood from the following detailed description taken in conjunction with the accompanying drawing of which:

FIG. 1a is a schematic representation of a personal computer illustratively depicting the personal computer including a computer-readable medium including computer-executable instructions for an operating system and the PWAA software and its components installed on the computer;

FIG. 1b is a schematic/line drawing of a standard personal computer “desktop” user interface with icons for shortcuts to run applications and the PWAA software including a PWAA interface residing on top of the desktop;

FIG. 2 is a screen capture of a word processing application after the user has done a left mouse click on the virtual button of the PWAA that is labeled with the name of the word processing application;

FIG. 3 illustratively depicts the desktop user interface as background, with the PWAA after a voice-over-Internet-protocol (VOIP) application has been started using the bottom right hand key of the PWAA, and the PWAA has changed the PWAA interface into a standard telephone dial pad graphical user interface;

FIG. 4 is a screen capture of the home page of an airline website opened by a click on the key/display of the PWAA interface allocated to the URL of that website and labeled with a title associated with the name of the website;

FIG. 5 is a screen capture of a website providing access to online videos after that website has been launched using the PWAA by selecting a virtual button with its virtual display labeled to indicate the URL that will be launched, which URL is part of a group of middle keys associated with a sub-group launch left hand key which, itself, is associated with the group aggregation key in the right hand key column;

FIG. 6 illustratively depicts the PWAA application interface in its always-on-top window on top of a browser with a website home page launched;

FIG. 7 is a screen capture of a website home page after that website has been launched using the PWAA as shown in FIG. 6, and after the “username” name virtual button has been pressed and held for more than the time period specified in the PWAA software database field to differentiate a single press on a PWAA key from a long press on a PWAA key), whereby the PWAA has changed its mode into text entry;

FIG. 8 is a screen capture of a username having been entered in the username window/box opened by the PWAA software after the user has performed a long click on the key allocated to username in the PWAA's current mode;

FIG. 9 illustratively depicts a personal computer's standard desktop user interface populated by a number of application shortcut icons, and also illustratively depicts the PWAA running, with the PWAA interface in a website playlist mode of news sites;

FIG. 10 is a screen capture of a website home page, with the PWAA interface illustratively depicted having changed modes into the next mode in the sequence assigned in the software and database for URL middle key activations;

FIG. 11 is a screen capture of a news website with the PWAA interface illustratively depicted in a text mode;

FIG. 12 is a screen capture of a news website with the PWAA interface illustratively depicted in its mode when a virtual key that has been dedicated to the “back” functionality is selected by the user, thereby changing the PWAA from the text mode shown in FIG. 11 to the website playlist mode;

FIG. 13 is a screen capture of a website launched by a press on the applicable middle key as a sequence from FIG. 12, demonstrating the PWAA providing the user a means of launching websites within a website playlist;

FIG. 14 illustratively depicts a standard desktop user interface and the PWAA with a right hand key 143 labeled “Web Favs” that has blank sets of middle keys and left hand keys;

FIG. 15 illustratively depicts a screen capture of the next sequence established in the PWAA software and database upon the pressing and holding of a URL launch key;

FIG. 16 illustratively depicts a screen capture of the data to be stored in the URL field prompt box being set by a user;

FIG. 17 illustratively depicts a screen capture of the PWAA after the user has selected “OK” (or enter) after completing the URL prompt box and ending text mode;

FIG. 18 is a screen capture of a browser showing a home page of a news website launched after the user has entered and stored a URL in the PWAA database, and then has performed a click operation on the virtual key/display of the skin image of the PWAA which contains the label chosen and entered by the user into the database to identify the URL;

FIG. 19 illustratively depicts a screen capture of a standard desktop user interface with a browser shortcut icon, as well as the PWAA in a mode selected among the right hand keys showing the active right hand key highlighted, with an ad impression displayed by the PWAA software as the cursor is tracked to a position in relation to a virtual key/display for which the applicable fields in the PWAA database indicate that an ad impression is active;

FIG. 20 is a screen capture of an airline website as launched using the virtual key/display described in FIG. 19 that had the super-imposed image displayed when the cursor was located by the user over the virtual key/display;

FIG. 21a illustratively depicts the PWAA application being incorporated into a portable/cellular phone—as represented by a telephone outline/skin image;

FIG. 21b illustratively depicts the scrolling of the right hand column of keys/displays, with an extended set of example labels from the applicable right hand key label fields extending down in the numerical order assigned them in the database fields as they will appear as the right hand column keys are scrolled down;

FIG. 22 illustratively depicts an exemplary flow chart summarizing the operation of exemplary software for the PWAA application;

FIG. 23 illustratively depicts a set of rules for the software engine for the operation of the PWAA keys/displays in relation to the skin image and the database;

FIG. 24a illustratively depicts a database structure for the main components of the PWAA database maintained on a computer-readable medium of a computing device;

FIG. 24b illustratively depicts additional detail for the organization fields of the PWAA database that determine, among other items, the number of right hand keys in each user's implementation of the PWAA;

FIG. 24c illustratively depicts additional detail for fields in the PWAA database that define characteristics of the user;

FIG. 24d illustratively depicts additional detail for fields in the PWAA database that define characteristics of each right hand key in the PWAA for a user;

FIG. 24e illustratively depicts additional detail for the master set of fields in the PWAA database that define characteristics of left hand keys; and

FIG. 24f illustratively depicts additional detail for the master set of fields in the PWAA database that define characteristics of middle keys.

### DETAILED DESCRIPTION OF THE DRAWINGS

### 1. The General Arrangement

Attention is directed to a set of associated figures that follow this description. The figures illustratively depict a user interface and associated systems and database, referred to herein as a personal web and application assistant (PWAA) application that provide a combined desktop and browser user interface.

The PWAA application consists of a core PWAA software engine, a database, one or more display images and, optionally, a set of one or more specific applications.

The software engine runs the user interface operations, maintains the database, communicates with other applications and the device operating system and communicates with remote servers via wired or wireless connections. The software engine operates the user interface in accordance with a set of rules, primarily: a first set of scrollable virtual keys/displays lets the user see and choose to launch websites, aggregations of websites (also referred to as website playlists), applications, aggregations of applications (also referred to as application playlists); a separate, second set of scrollable virtual keys/displays lets the user select among options within the selected first key/display; and a third, separate set of virtual keys/displays that lets the user operate the websites/applications/mode the user has defined by selecting from a first set key and a second set key. The software engine's rules also control the operations within each of the three sets, and also determine what is user and/or third-party modifiable within each set of virtual keys/displays.

The first set of virtual keys/displays is sometimes referred to herein as the right hand column keys or right hand keys. The second set of virtual keys/displays is sometimes referred to herein as the left hand column keys or the left hand keys. The third set of virtual keys/displays is sometimes referred to herein as the middle keys. These alternative references are used to facilitate cross-referencing into the figures that illustratively depict an implementation of the PWAA application and its associated graphical user interface (PWAA interface). Also, the terms “key,” “button,” “virtual key” are used interchangeably, as sometimes are “display” and “virtual display” and “simulated display.” The terminology also sometimes refers to “keys/displays” because these can be implemented to appear to the user as a single construct or separated, and, if separated, there functionality can be co-mingled, such that, for instance, a mouse click on the virtual display associated with a separate key performs the same function as a mouse click on the key itself.

The virtual displays/keys may have sub-areas of them to which additional functionality is assigned. For instance, if the respective fields in the PWAA database have been configured to indicate to the software engine to do so, an upper right hand square area of a virtual display/key may display a “?” and, if the user selects that area of the virtual key/display, the software engine presents the user with information as the currently-assigned functionality and use of that virtual key/display based on the help information in the database field associated with that key, which is implemented, for instance, as a link to a help file or a link to a website with help information for that key/display.

The database is structured to map to the three sets of keys/displays, and the core engine maintains the database and uses the database in accordance with the rules contained in the core engine that apply to each of the fields in the database and each of the three sets of keys. The database contains an expandable array organized in a hierarchy, with a set of fields for the first set of keys/displays that contains, for each such key/display: the data to be displayed in association with that key, a set of data associated with that key, and a pointer to the database fields for the second set of keys/displays associated with that first key, among other information. The database fields for the second set of keys/displays contain, for each such key/display for each key/display in the first set of keys/displays: the data to be displayed in association with that key, a set of data associated with that key, and a pointer to the database fields for the third set of keys/displays associated with that first key, among other information. The database for the third set of keys/displays contain, for each such key/display for each key/display in the second set of keys/displays associated with a first set key/display: the data to be displayed in association with that key, a set of data associated with that key, among other information. The data fields associated with any key/display include the information to be displayed in association with that key/display in the image the user sees, the action to be taken by the software engine when that key/display is selected by the user, an identifier as to the type of action to be taken when that key/display is selected by the user (e.g., launch a website, launch an application, enter a command for an application, enter data into an application, modify the database, scroll a set of keys, etc.), one or more identifiers and flags as to the rules and settings applicable to the key/display (e.g, user modifiable/non-modifiable data, permissible types of actions/data associated with that key/display based on which set of keys/displays that specific key/display field is allocated to, RSS (or other dynamic information/advertising/marketing content) feed information for that key, etc), as well as other information.

The software engine of the PWAA application consists of (1) code to manage the virtual keys/displays and user interaction with them, (2) code to access the database fields based on the user's interaction with the virtual keys/displays, (3) code to maintain and update the information in the database, (4) code to display, track and report on content/advertising/marketing information presented in association with the virtual keys/displays, and (5) code to track and report on database content and usage information.

The display image for the PWAA application consists of an image displayed on the main screen of the device (which image is moveable by the user, as well as minimizable, maximizable and, depending on the display image type, re-sizeable), and a set of virtual (or simulated) display areas in the image where the data from the database is displayed in accordance with the user's operation of the software and the engine's rules for displaying data. The virtual display areas may be adjacent to or combined with simulated keys that are operated by the user by positioning the cursor over them and activating them by pressing the click key of the device and/or pressing and holding the click key of the device, in the case of a physical key mouse and keyboard device, and by activating the functionality of a click by touching the main screen with the finger or stylus/pen in the case of a touchscreen device.

In essence, the user interface of the PWAA application and its database work in a hierarchical manner determined first by the identification of the current user of the PWAA application (in a multi-user installation), second by the user's choice of right hand column key, and third by the user's choice of left hand column key (from a selection of left hand column keys deterministically ascertained by the user's choice of right hand column key), all of the following together deterministically determine a set of middle keys.

Within that background for the PWAA application, the first set of virtual keys/displays include keys/displays that display a user-generated or pre-established name for an application or website, and, when selected, directly launch that website or application. For a website, the software engine uses the default browser software on the device to directly access and display the website. If the browser is not currently running, the software engine opens the browser, with the selected website being the website shown in the browser window.

The first set of virtual keys/displays also includes keys/displays that display a user-generated or pre-established name for a group of applications or websites, and, when selected, change the second and third set of keys of the PWAA interface whereby the second set of virtual keys/displays one or more names for sets of related applications or websites, and the third set of keys/displays initially, shortcuts to the applications or websites related in the database fields to the first and second sets of keys/displays in the database. A selection by the user of the second or third (etc) of the keys/displays in the second set of keys/displays changes the third set of keys/displays to provide access and display the shortcuts to the applications, websites, commands or text related in the database to that selection among the active set of second set of keys.

When a user selects an application or website shortcut using the PWAA application, the software engine directs the operating system of the device to execute the run file for that application or directs the browser on the device to launch the URL for that website (the shortcut to the application having a pointer in the database, and the URL for the website being stored in the database), and changes the mode of the user interface sequentially as directed by the information in the database related to the applicable keys in the PWAA interface and the rules of the software engine in order to maximize the user's experience of the application or website the user has selected. If the browser is not currently running, the software engine directs the device operating system to run the browser, with the selected website appearing in the browser window as if it were the default home page of the browser.

For most websites launched in this fashion by the user, the PWAA application changes a second set of virtual keys/displays within the PWAA interface to the following: password controls, browser controls, screen controls and text mode. The first of these is password controls, and, as described above (being defined in the database as the top left hand key in the database in the case of a key press accessing a URL field in the PWAA database), is the default that the PWAA software engine activates. In the password mode, the third set of keys displays a key that accesses (and permits the user to customize) the user's password for that website stored in the database, as well as a key/display for the user name for that user for that website, as well as key that permits the user to skip entering a password or username and a key that permits the user to send a command to the website that a username and password have been entered. The database contains fields for the actual username and password as entered by the user a first time (and, optionally, as modified by the user at other times), and a separate field for displaying a shortcut security name for the password and username on the applicable keys/displays on the image. On the website page, the cursor is positioned in the username and password boxes, and the user enters the username and password using one click by pressing on the key/display for the username and the password. The database includes encryption capability for the stored username and password, as well as, depending on the security circumstances as set in the applicable database fields based on users' or administrators' preferences, some or all of the rest of the database.

The database contains a set of pre-programmed first, second and third sets of keys for both applications and websites. The user interface allows the user to modify these pre-programmed settings, subject to the limitations imposed by the rules established in the PWAA software engine and in the structure and fields of the database. The software also enables the developer of the PWAA application (or third parties authorized by the developer, which information is also stored in the database in fields related to each application and website key/display information) to modify or update the data fields (in accordance with the rules in the software engine) after installation by the user of the software. For instance, one or more URLs and associated display names can be updated from time to time by the developer to add to or change related first, second or third sets of keys by download to the database from remote servers. Also, by way of example, a website service provider (such as Facebook) can be permitted to change the sequence of and information in the database for second and third sets of keys once a user has accessed and logged into the service provider's website in order to enable the service provider to give the user the optimal user experience of the website's functionality via the PWAA interface.

Using a computing device executing the PWAA application, the user can organize and access applications and websites identically, without directly using the desktop user interface or starting a Web session by first opening a browser using a desktop browser icon, then reaching a default home page URL and then entering in a URL, accessing bookmarked sites or searching for a site using a search engine.

The PWAA interface contains a set of virtual keys/displays dedicated to selecting among sets of applications or websites (as well as other modes of the PWAA application, such as text entry mode). The left hand and right hand columns of keys have a scrolling ability such that there are as many in this list of individual keys as the database and memory in the device permit.

One or more of each of the virtual keys in the right hand column is assigned the name of a group of applications or websites. This assignment is done in advance of installation of the software, and also is customizable by the user, and may be done after installation by a remote party over a Web interface (such as a cable modem, DSL, WiFi, telephone or other connection between the device on which the user interface is installed and the Internet).

The right and left hand columns of keys have an integral, uni-directional press-to-scroll functionality indicated by the grey up and down arrows. By pressing and holding these keys, the user scrolls through the list of all URLs, applications and features on or available through the device that have been assigned to direct launch keys, in order. The scrolling enables a virtually infinite list of direct launch keys, listed and scrolling in an order determined by the software and data structures for the keypad interface.

The PWAA software implements rules that are also, in whole or in part or expanded upon, distributed to developers as part of software developer kits that enable third party application developers to enhance or optimize their applications consistent with the underlying operational rules of operation of the PWAA application, as coded into its software, as well as the structure of the database and some of the information in the database. For instance, a rule for the first section of virtual keys/displays is that the top right hand key and its associated display are locked by the software for most or all contexts in order to provide the user with an immediately available and visible means to switch the PWAA application into its home state mode. The scroll functionality only applies to the dedicated launch keys below the top right key if the applicable database field for that key and/or the PWAA software rules specify that the top right key is locked in place. This rule prevents third party developers from overriding these settings in the database.

The PWAA interface's array of virtual keys and displays is implemented in the screen captures illustratively depicted in the figures using separate screen areas for the keys and the displays. Alternatively, the virtual keys and the virtual displays may be allocated the same screen area, thereby either (1) increasing the overall size of the active area for using a left mouse click to activate the functionality represented by the information shown in that area, or (2) decreasing the overall footprint of the “skin” image of the PWAA interface.

In the figures, the scroll up and down functionality for the left and right hand columns of keys/displays is integrated into the two middle buttons of each of the columns, and is activated by pressing and holding either the scroll up or scroll down keys. Alternatively, one or more separate scroll up or down virtual keys can be used to scroll up or down the list of applications and URLs appearing in the displays of the PWAA application. Also, alternatively, there can be less than or more than four of the virtual keys/displays in each of the columns, and more or fewer than twelve of the middle set of keys/displays. And, the locations of each of the three sets of keys in relation to each other can be different than is depicted in the figures, provided that the depicted locations are the preferred embodiment from an ergonomic perspective, particularly in touchscreen implementations that permit finger activation of the keys/displays.

Four keys/displays making up the left and right columns (1×4 arrays), with the right being the default column for the dedicated launch keys is a preferred implementation for a number of reasons, including, for instance, ease of ergonomic use, a sufficient number of scrolling keys (plus a top key locked to start mode, as described above), and optimal text entry mode. The PWAA software can provide the user with the ability to change a left/right hand setting, automatically switching the PWAA's dedicated launch key column from the right hand side to the left hand side. Twelve keys in the middle is also preferred because, for instance, of its familiarity to most people as the number of keys on standard telephone keypads and calculator keypads.

A virtual key in the dedicated launch key column can be allocated the role of an aggregator for a category or type of application or URL. When such an aggregator key is pressed, the middle twelve keys display a set of applications or URLs that fit that category. For instance, an aggregator key titled, for example, “News” and the middle twelve keys when that aggregator key is selected, for example, displays one or more of www.cnn.com, www.nytimes.com, www.wsj.com, www.bbc.org, etc. These can be pre-set, set by the user or set remotely. A mouse click on one of these middle twelve keys performs a direct, one-click launch of that URL or application. The left hand column keys can provide access to subsequent sets of launch keys within the same aggregation category. The software and database contain functionality controls such that a click on a middle twelve key (or other) dedicated launch key results in a click through fee, in this case a click in an application (as opposed to a website), results in a click-through fee to the entity owning or representing the website, web content or application that is launched/accessed using that key.

Aggregation keys can be determined according to a number of factors, including, for instance, subject matter of URL (e.g., news websites, video websites, search websites, social network websites, etc.), a company with multiple offerings by application or URL (e.g., Google with Google search, Google apps, etc; or Microsoft with Word, Excel, Powerpoint, Visio, etc.), subject matter of application (e.g., mobile gaming or ringtone websites), or user favorites (potentially analogous to playlists or “most-played” on MP3 players).

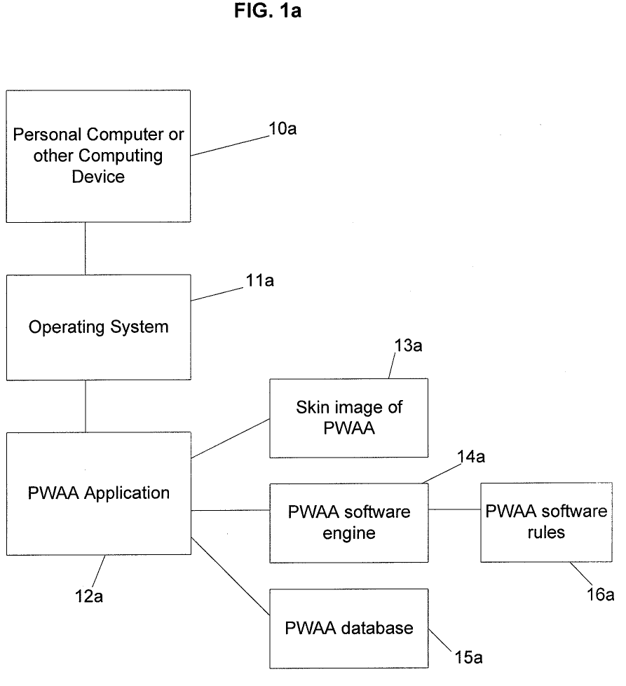

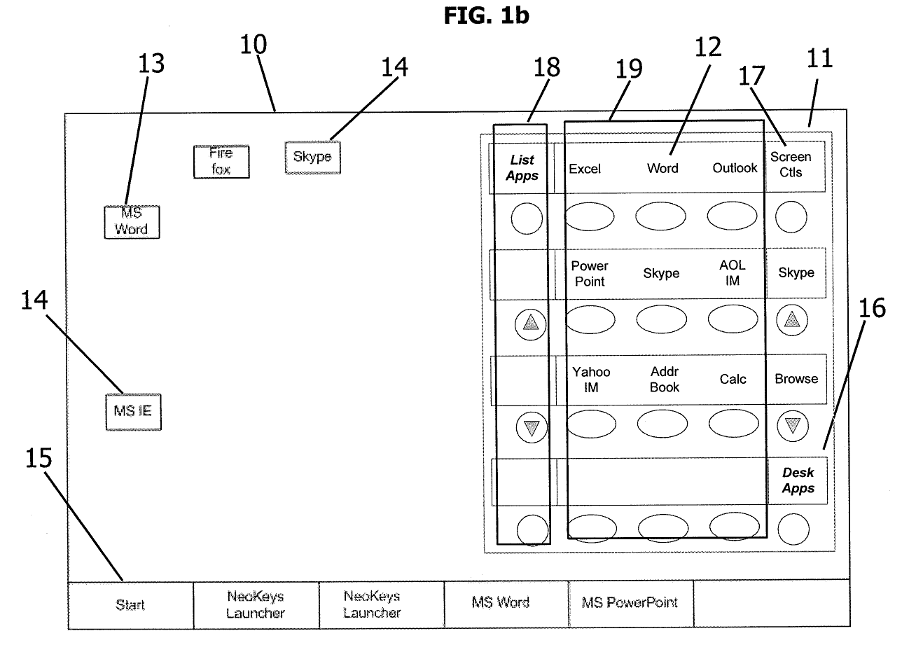

FIG. 1a illustratively depicts a personal computer or other computing device 10a with an operating system 11a resident on it, and a PWAA application 12a installed on it. The following PWAA components are also illustratively depicted: an image 13a that is presented to the user on the computer device's monitor; a software engine 14a that serves to place the image, manage the cursor activity over the image thereby driving the functionality of the PWAA application 12a, and manage the operation of the PWAA in relation to the operating system 11a and other applications; a PWAA database 15a where the data is stored and managed that, in addition to the PWAA software engine 14a, governs the operation of the PWAA application 12a; and PWAA software rules 16a that determine aspects of the PWAA application.

FIG. 1b illustratively depicts a screen capture of a standard Microsoft “desktop” user interface 10 with icons for shortcuts to run applications and a PWAA interface 11 residing on top of the desktop 10. Some of the desktop icons are for the following applications: a Microsoft Word application 13 and two browsers 14—Internet Explorer and Firefox browser. The desktop also has task bars, with the “Start” key 15 which gives users access to all applications installed on the device (whether or not they have desktop icon shortcut).

The PWAA interface 11 is shown in a “Desk” mode 16—which places certain work-type applications in the displays of the middle twelve keys, as set in the database fields accessed using the right hand key select, the left hand key select (subject to the right hand key select), and then the field for the applicable middle keys. By clicking on a key associated with an application, the PWAA application directs the host computing device's operating system to run the application, or, if it is already running, to make it the active application.

For instance, the Word application is shown in a virtual display 12, and a left mouse click on the virtual button immediately underneath that display starts the Word application, without any need to use the desktop Word icon 13 or finding the Word application using the “Start” key 15.

FIG. 1b also illustratively depicts a right hand key 17 labeled “Scrn Ctls”. Selecting the Scrn Ctls key 17 key places left hand keys 18 and middle keys 19 into a mode that controls the monitor and/or active display areas on the monitor, such as zoom in/zoom out, print screen, scroll up/scroll down, scroll left/right, minimize, maximize, etc. This is exemplary of the capability of the PWAA application and associated PWAA interface to replace the personal computer standard command entry system of pull-down menus from task/command bars at the top, bottom and sides of the screen and/or application areas showing on the display/monitor by presenting the commands on the keys/displays of the PWAA interface using the identical system as the PWAA application uses for accessing, opening and using websites and applications. The PWAA application embeds in the database in association with the applicable fields for each key either a direct set of commands, an executable or script for that command or a set of code that activates the applicable application or system command. These fields are accessible by third party application developers, subject to a set of software rules and guidelines, such that third party application developers have the ability to create an application launch key in the PWAA interface and a set of application command keys for that application, in order to enable applications to utilize the capability of the PWAA application to minimize or eliminate the need for task/command bars and pull-down menus for entering application and system commands. In other words, the PWAA application is an application and system command entry user interface for any application, and the PWAA application does not rely on task/command bars and pull-down menus, and is programmable (subject to conformity with its underlying structural rules) by third party programmers. As the size of monitors become larger and smaller to more than approximately twenty inches in diagonal and smaller than approximately ten inches in diagonal, the importance of a system that does not rely on task/command bars that stretch across a few feet of space (in the case of large monitors) or that do not fit at all (in the case of small monitors, such as those on handheld devices) but that still allows entry of a full set of the commands required by advanced applications becomes ever more pressing. Further, even on mid-size monitors, task bars in many applications are frequently an inch or so wide vertically to accommodate all the commands and third party add-ons. The explosive growth of the task/command bar system is taking up an increasing amount of the viewable area of the screen, leaving smaller areas for viewing the actual content that the user is attempting to view and use, a problem that the PWAA application's command entry system resolves.

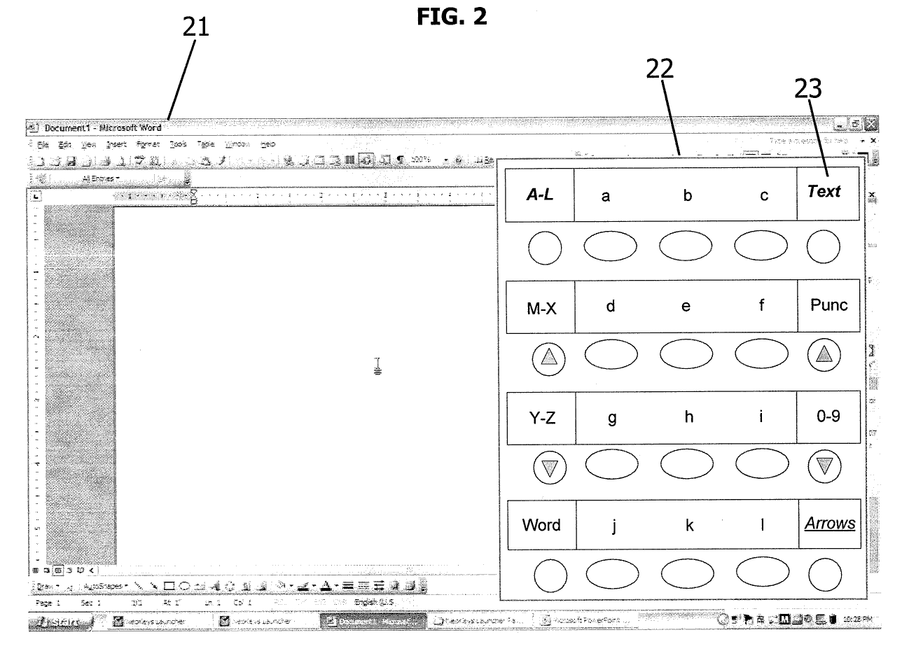

FIG. 2 illustratively depicts a screen capture after the user has done a left mouse click on the Word virtual button 12 of FIG. 1b. The desktop user interface is updated, in the view of the user, to display a window in which a Word application 21 is running. A PWAA interface 22 has changed its mode into a text entry format 23 consistent with the needs of a user of a word processing application such as Word. Using clicks on the letters/text mode of the PWAA application, the user has the capability of a full PC keyboard to enter text and control the word processing software capabilities.

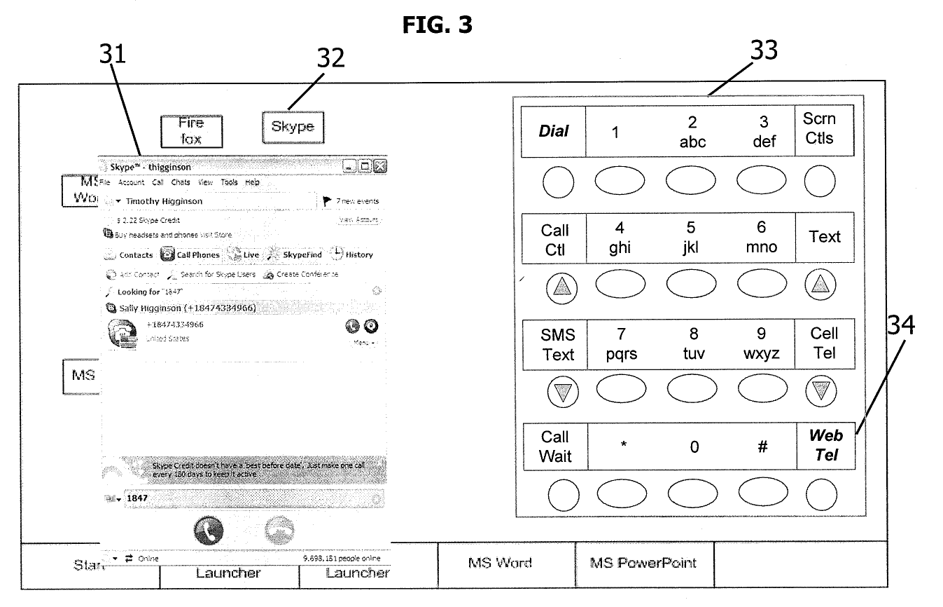

FIG. 3 illustratively depicts the desktop user interface as background, with a PWAA interface 33 after a voice-over-Internet-protocol (VOIP) application 32 has been started using the displayed, allocated functionality of a bottom right hand key 34 of the PWAA interface 33, and the PWAA application has changed its interface 33 into a standard telephone dial pad interface consistent with the needs of a user dialing a telephone number (in accordance with the mode sequence information contained in the database fields applicable to the selection of the virtual key/display that is then assigned to launching the (VOIP) application. By using the telephone number dial pad, the telephone number is entered directly into the number dial box of the VOIP application.

The above description illustrates a direct launch of an application using the PWAA application and its associated graphical user interface as opposed to the traditional methods of running an application by clicking on a desktop icon shortcut or finding the application's name in a list of applications shown in a menu pulled down from a task bar or displayed after hitting one or more keys in the bottom task bar, and then clicking on the name of the application to run it.

As will be seen from the subsequent figures and description, the PWAA application also launches in an identical manner websites, groupings of websites, applications and groupings of applications, thereby giving the user a single, integrated control interface for both the Internet and applications resident on the user's device.

The database for each application launch key has a field for the key display content as well as the execution instruction for the application assigned to that key. The key display content can be the text name of the application (in whole or abbreviated or abridged) or an icon or other graphical representation of the application. Further, the application launch key content and execution instruction can be user customizable. For instance, the user can drag and drop a desktop icon shortcut for an application directly to the virtual button or its associated display which will re-assign the applicable instruction field in the database to the run instruction for that application as well as re-assign the display area content to display the icon, subject to certain embedded software rules and security precautions, such as to prevent the user from inadvertently changing key assignments and to maintain the structural operations of the PWAA application and the integrity of the structure of the database.

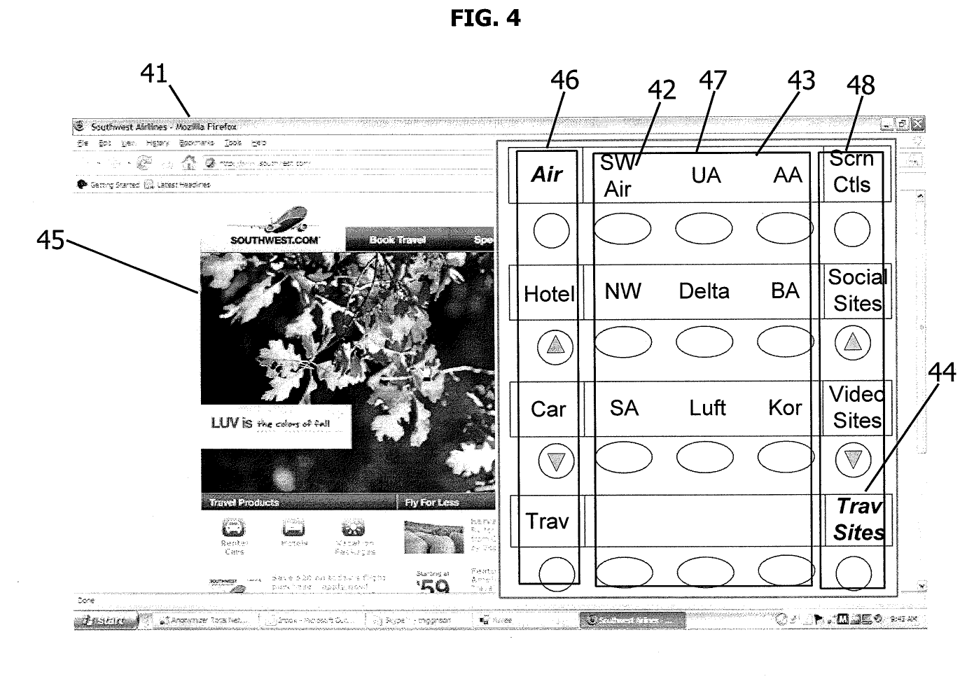

FIG. 4 illustratively depicts a screen capture 41 of an illustration of a PWAA interface 43 with the home page of an airline website 45 behind it. The PWAA interface 43 launches directly into subpages of websites as well as home pages, based on a URL that is associated with web launch keys in the applicable database field of the PWAA application, which URLs are user customizable. An alternative implementation of the database locks one or more keys in each grouping of websites such that those keys are not customizable by the user, but, instead have the URLs associated with those keys set in the database by access from a remote server with software that synchronizes those URLs to the sets of locked keys. The groupings of websites in the middle twelve keys shown in this FIG. 4 are airline websites, with a user launch key in a right hand column 48 named after the larger grouping of all a left hand key sub-groupings 46. In this example, the right hand key 44 is labeled “Travel Sites”. The sub-grouping keys 46 are labeled “Air”, “Hotel”, “Car” and “Trav” in the fields of the database for this right hand key 44 and determining and providing the database pointer information to the fields containing the information for this mode for a set of middle keys 47. The “Air” sub-grouping is active, meaning that the middle twelve keys 47 are assigned the URLs and the associated labels for each URL for nine of the twelve middle keys, and a press on any of these will launch directly into the URL associated in the database with that key. In the instance depicted in FIG. 4, the Web page corresponding to the URL www.southwest.com is shown after it has been launched by pressing an upper left key 42 of the middle twelve keys labeled “SWAir” for which, in the database, the URL www.southwest.com is assigned. The user does not have to have already launched the browser, whether Internet Explorer, Firefox or another browser. The effect of pressing the key 42 is to launch the default browser if it is not already running directly to the applicable URL. If a browser is already running, the effect is to open a new “tab” for the URL if the browser permits that functionality.

The user does not have to remember or type the URL, nor does the user have to use a search engine to find the URL if he/she does not remember it. Once a URL for a Web site is in the database and thus assigned to a key, the user accesses the website simply by clicking on the virtual key/display with the label (either pre-assigned or assigned by the user) shown for that key.

In the instance shown in FIG. 4, the skin for the PWAA application depicts separate virtual keys and displays, but the separate keys and displays can be integrated into a single display area, or, alternatively, the display area that effects a virtual click of the button can include both the area depicting graphically the button and the area depicting graphically the display associated with the button. Further, while the screen capture shown in the figure depicts text in the virtual displays, icons or other graphics (or a combination of text and graphics) can be shown in the virtual display, such as the icon for a shortcut to an application as used on the desktop user interface. The fields in the PWAA database contain the information required for the PWAA software engine to display the applicable content. The content include a default set of information to be displayed, with additional fields for additional or enhanced information to be displayed based on additional flags set in the database by the PWAA software depending on various conditions that are pre-set at time of install of the PWAA and are changed during operation of the PWAA software subject to the PWAA software receiving instructions to add or remove display information based on the user's input and also based on remote servers communicating with PWAA software through wired or wireless links to the computer on which the PWAA is installed.

When a right hand key is selected, the default middle twelve keys are assigned the values in the database as if the user had also selected the top left hand key, as its value is assigned in the database for the selected right hand key. Hence, the database is structured in a manner that reflects the operational system behind the user interface: Right hand key, a set of left hand keys associated with each right hand key and a set of middle keys associated with each left hand key.

The exact number of right hand keys, left hand keys and middle keys is determined either dynamically, or based on the expected number of right hand keys (and associated left hand keys) needed for the context—such as the type of device, or based on other parameters. The roles of the right and left hand keys can be reversed by a user preference setting, allowing for dynamically changing the user interface for left-handed and right-handed users. Further, the nomenclature “right hand column keys” or “right hand keys” and, similarly, the “left” keys may be re-assigned locations in the user interface such as above or below, so long as the operation of the so-called “right” hand keys drives the operation of the so-called “left” hand keys, which, in turn, determine the functionality of the so-called middle keys. This core operational structure of the PWAA application is protected by rules embedded in the software and in the structure of the database, such that while the database is customizable at certain levels (such as assigning URLs and labels to virtual keys/displays; creating new groupings or sub-groupings; importing or exporting a key groupings' set of database fields; etc.) whether by the user, the entity controlling the PWAA application or third party application developers, these customizations cannot alter the core patterns of use of the PWAA application.

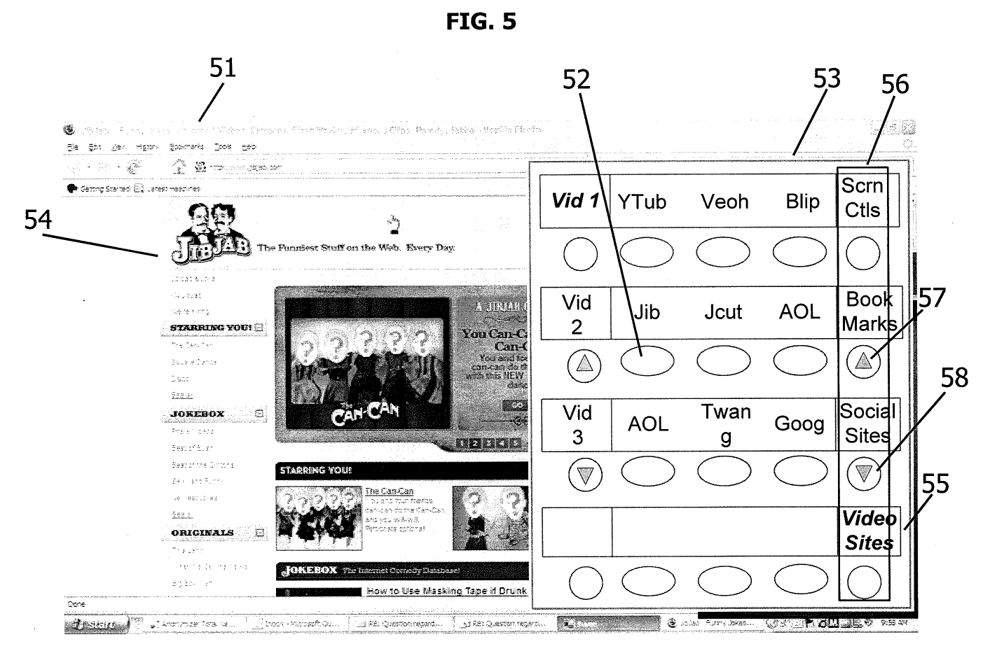

FIG. 5 illustratively depicts a screen capture 51 of a website home page 54 after that website has been launched using a PWAA interface 53 by selecting a virtual button 52 with a virtual display labeled to indicate a URL that will be launched, which URL is part of a group of middle keys associated with a sub-group launch left hand key which, itself, is associated with a group aggregation key 55 in the right hand key column. FIG. 5 shows a right hand key column 56 having been scrolled from the right hand keys 48 shown in FIG. 4 to display and access a new set of right hand key values in the database. The database structure contains a list of right hand keys that is larger in number than the four displayed at any one time. By various scrolling means—exemplified in the instance shown in the FIG. 5 by up 57 and down 58 arrows in the middle two keys of the right hand column keys—which up and down scrolling functionalities are activated by a simulated pressing and holding of those keys by means of a click of a mouse with the click button being pressed and held in the click position thereby causing the software, after a default period of time (e.g., 0.5 seconds, as stored in the database either as a default period of time for all keys or on a per key or per-key grouping basis) to begin scrolling rather than to effectuate a click of the virtual key, and, as the software selects through the database of right hand keys, the value of each sequential right hand key is displayed in the displays above each key sequentially in a scrolling manner up or down as applicable based on the user's selection of up or down scrolling functionality. By this means, the user sees each option of right hand key functionality in the database (essentially using the keys/displays on the skin image of the PWAA application as a visual navigation tool through the database), and can stop scrolling and then press the virtual button associated with the virtual display label that activates the functionality selected by the user.

The PWAA software engine also contains certain other control parameters associated with the scrolling functionality. For at least certain types of computing devices, such as cell phones, the top right hand column key can be restricted from scrolling, and, instead, provides the user with an instant re-set to the first setting in the database, giving the user a one-click access to a “home base” in the database functionality for the entire PWAA application. For a mobile phone, this first functionality in the database is the telephone functionality that re-sets the middle keys to a standard telephone numeric keypad. This “home base” right hand key can also be set in the software to cause all four of the right hand keys to display the first four (or a set of four) functionalities assigned in the database to the right hand keys.

Another structural level of the database that is reflected in the user-view of the PWAA application's graphical user interface is that of meta-right hand keys. A meta-right hand key has not only its primary functionality assigned to it in the database, but also a set of additional right hand keys that do not appear during regular scrolling but automatically appear when the meta-right hand key is selected, and automatically disappear from the displays shown the user when any other right hand key not associated with the meta-right hand key is selected. This permits a smaller scroll list for the user at the top-level of right hand key functionality, while also permitting the user interface to be optimizable across left and right hand keys for specific functionality, such as text entry, or, alternatively, to permit access to a group of right hand keys with related content/functionality that the user does not need or want to see individually each time the user scrolls the right hand column of keys.

The right hand key column's bottom key permits a press-and-hold functionality of its own, that operates via the software identically to the press-and-hold functionality of the scrolling middle two right hand keys and the home-base functionality of the top right hand key, but that has a distinct functionality role established by the software which is to give the user the means to re-name, move, delete or share (export) the part of the database associated with that right hand key.

The left hand column keys contain similar functionality—top “home base” key, scrolling up and down keys, meta-left key functionality, and customization/share/export key.

The database contains an entire set of right hand, left hand and middle key groupings by user, up to a pre-set maximum number of users, which pre-set number may be increased or decreased via an administrative or remote functionality, subject to the memory size limitations of the device on which the PWAA application is running.

Furthermore, the PWAA application permits remote storage, access and synchronization of the database settings for each user. Among other benefits, this permits each user to have the PWAA application running on multiple devices (such as a home PC, a work laptop and a mobile phone), and any modification from any of the PWAA application's database on any of these devices gets stored on the master copy of the PWAA database stored remotely (or on the device that the user designates as the device containing the master copy of the database), and it permits the user to have an identical database of functionality for the PWAA application across all of his/her devices that have the PWAA application installed so long as each device has access to the master copy of the database.

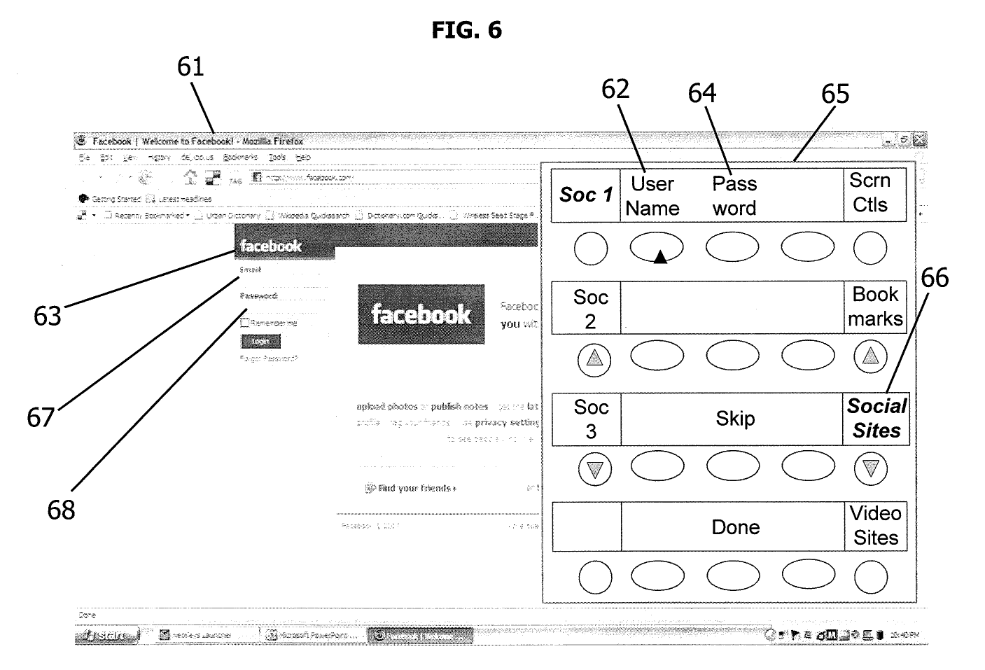

FIG. 6 illustratively depicts a screen capture 61 of a PWAA interface 65 in its always-on-top window (subject to minimize or close) on top of the browser with a website home page 63 launched. The PWAA interface 65 shows that the user has scrolled the right hand column keys and selected a key/display 66 associated with a grouping labeled “Social Sites”. The middle keys for social sites include a number of social website direct launch keys, one of which has been selected by the user which has launched the website shown. The PWAA application is shown in a mode that the PWAA application is, based on the indexing into the applicable database fields, using the indexing identifiers of the right hand and left hand numeric order fields (or other applicable identifiers, such as the information in the mode sequencing fields) programmed to display in the middle keys after a URL is launched, which mode gives the user access to a username key 62 and a password key 64, among others. Many websites require the user to enter a username and/or password in order to access some or all of the functionality of the website. These websites generally have boxes for the user to enter his/her password and username in order to log in. In the FIG. 6, a username box 67 and a password box 68 are present on the home page of the website. By positioning the cursor in one of these boxes, and then pressing either the PWAA interface's username key 62 or password key 64, the PWAA application accesses the user's password and username stored in the PWAA application's database in association with the URL launched via the PWAA interface 65, and enters the username and/or password with one click, with the user never having to type or remember the password or username he/she has selected for that website after entering them into the database a first time. The software encrypts the username and password in the database.

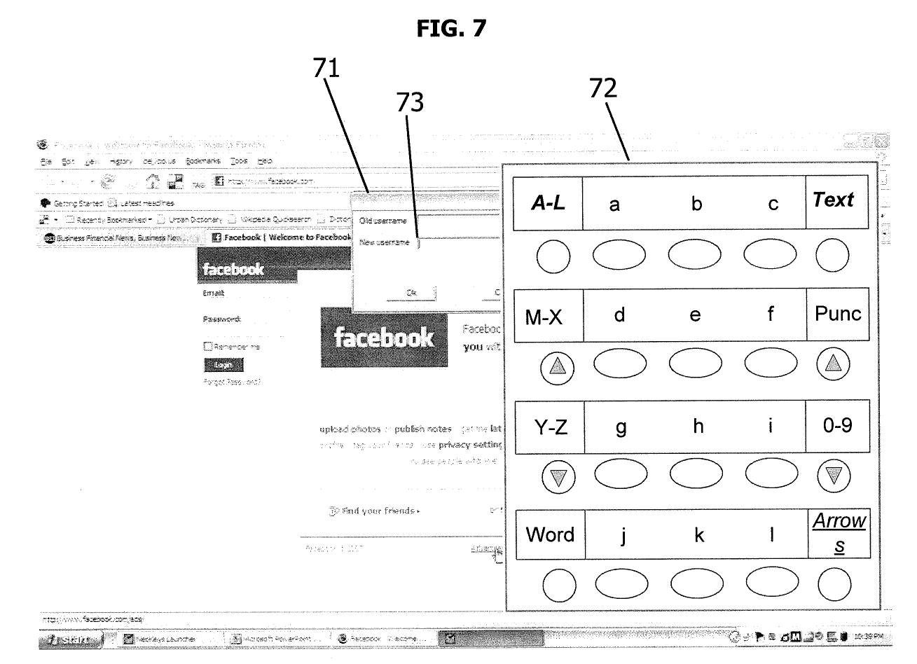

FIG. 7 illustratively depicts a screen capture of a website home page after that website has been launched using the PWAA interface 65 as shown in FIG. 6, and after the “username” name virtual button 62 depicted in FIG. 6 has been pressed and held for more than 0.5 seconds (or the time period specified in the applicable software database field to differentiate a single press on a key from a long press on a key) selected as also shown in FIG. 6, whereby the PWAA application has changed its mode into text entry 72 and the PWAA software has opened a window/box 71 and positioned a cursor 73 in a box in the window permitting the user to type using either the PWAA application's text entry keypad mode or the device's physical keypad (or an alternate virtual keyboard) a new username. When the user enters the new username and then presses “OK” in the username entry window (or presses “enter” using one of the device's user interfaces' “enter” keys), the software stores the new username, as typed by the user, into the PWAA application's database field relating that username to the URL launched by the user using the PWAA interface.

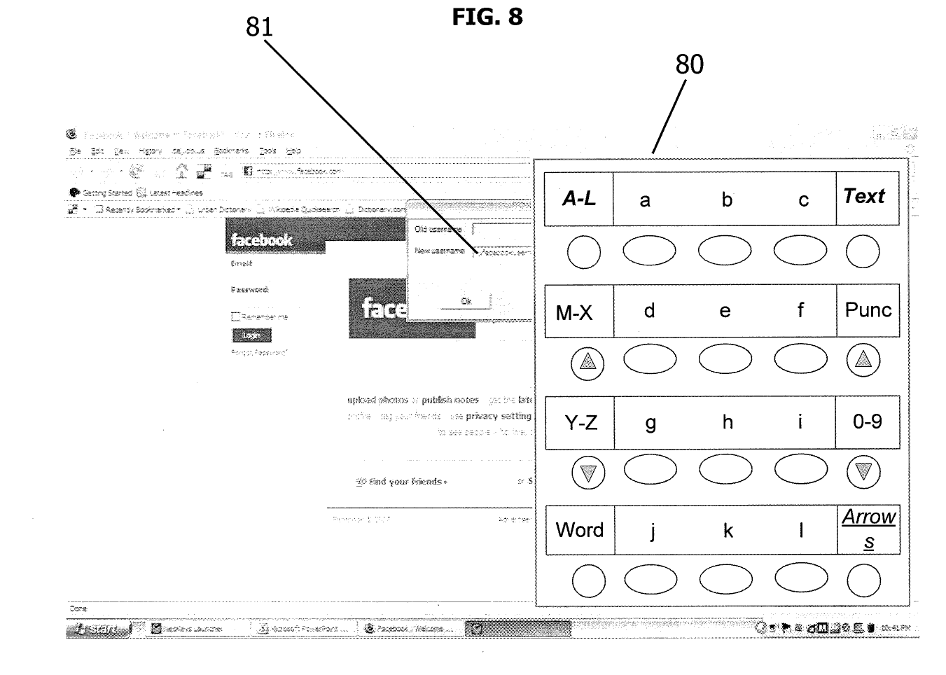

FIG. 8 illustratively depicts a screen capture of a PWAA user interface 80 including a username having been entered in a username window/box 81.

Using this same sequence of (1) pressing on a middle virtual key for a period of time established and stored in the PWAA software, and then (2) providing the user with a window/box prompt for data (which prompt may contain the pre-existing information from the applicable database field), and, at the same time, (3) having the PWAA application change into text entry mode, the user can re-set usernames, passwords, website URLs, whole phrases (in text entry mode), and emoticons (in text entry mode). In other words, a single consistent pattern of use is built into the software for the user to customize and personalize many fields (and different types of fields) in the database used and maintained by the PWAA application.

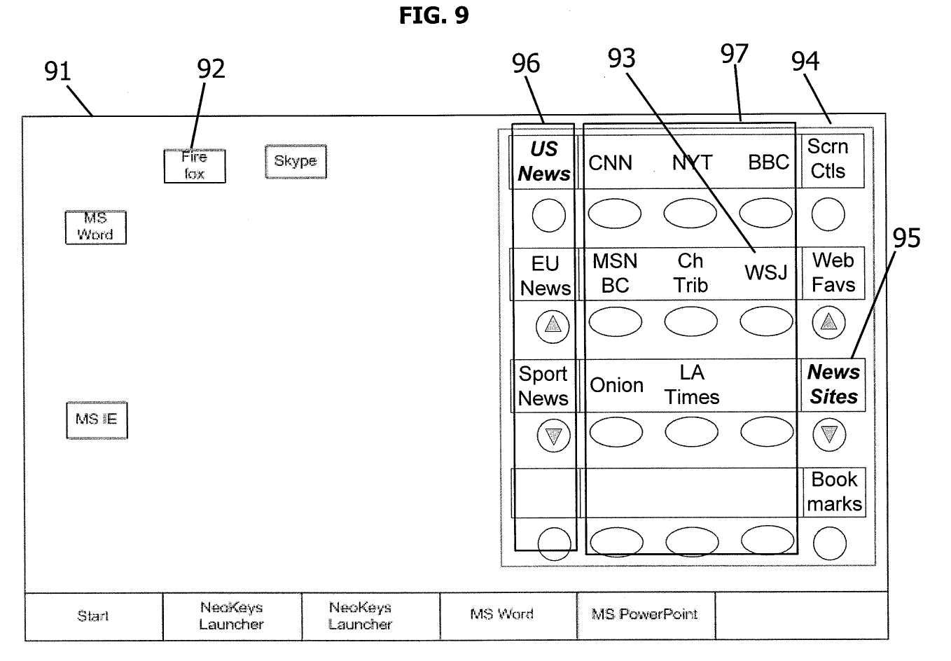

FIG. 9 illustratively depicts a screen capture of a standard personal computer desktop user interface 91 populated by a number of application shortcut icons, including, for instance, an icon 92 that launches a Firefox browser. The screen capture also shows the PWAA application running using a skin image 94, with the PWAA application in a website playlist mode of news sites. The user has selected the “news sites” mode by scrolling through the right hand column of virtual keys/displays, and pressing on a virtual key/display labeled “news sites” 95. Left hand column 96 and middle twelve keys 97 of the “news sites” mode have re-mapped themselves by the PWAA software upon the selection of the right hand key labeled “News Sites” 95 by accessing the database information fields for the “news sites” right hand key 95. In this instance, there are only three left hand keys identified in the applicable fields in the database, and, as is the default operation of the PWAA application, the upper left hand key is automatically selected as the default for the right hand column key, and, so, the PWAA software displays the labels from the PWAA database fields for the middle twelve keys applicable to the top left hand key, and the virtual buttons in the middle twelve keys are assigned the functionality and mode sequencing as similarly assigned in the relevant database fields.

In this instance, selecting the key 93 labeled “WSJ” launches the website www.wsj.com from the default browser. If the browser is not open at the time the button is pressed, the software directs the operating system to run the browser, and sets the website page as www.wsj.com.

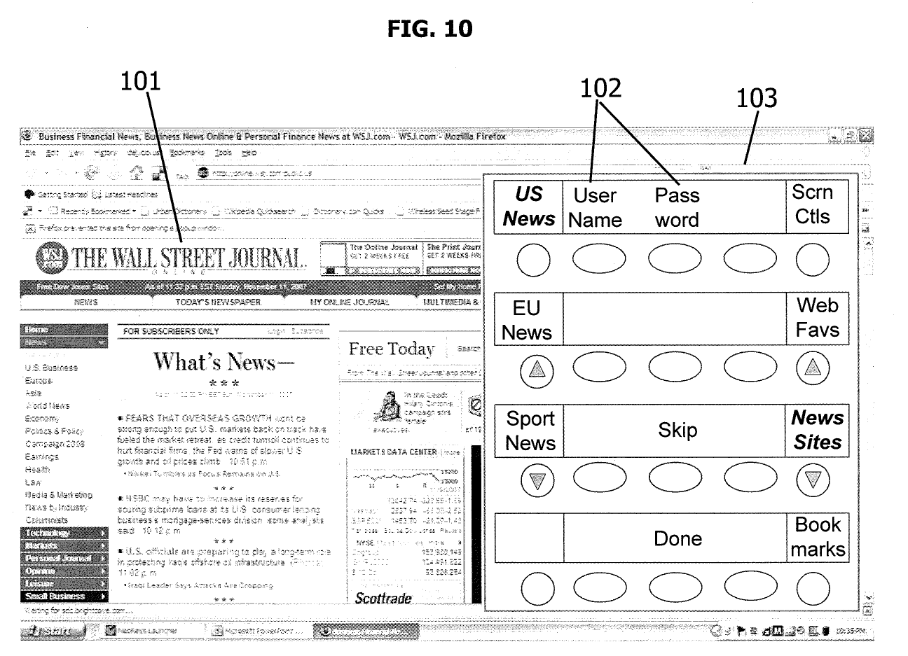

FIG. 10 illustratively depicts a screen capture of a website home page 101 (the www.wsj.com website launched as described in FIG. 9 description above), with a PWAA interface 103 having changed modes into the next mode in the sequence assigned in the software and database for URL middle key activations: in this instance, a mode that presents a password/username mode interface 102. In an alternative embodiment, a default sequence mode used by the software after a URL launch key has been selected by the user is a left hand key labeled Web Controls, and (2) middle twelve keys labeled (1) Browser Controls, (2) Screen Controls, (3) Text, (4) Password, (5) Site Controls, (6) Add-ons, (7) Back. When the user clicks on these, they switch the mode of the PWAA application as applicable. For instance, the “Browser Controls” changes the middle keys to give the user a set of browser control keys (without the need for task bars on the screen, thereby freeing up a larger screen area to display web images and content), such as home, back, new tab, refresh, etc. The “Screen Controls” interface button changes the middle keys to a set of keys that control the viewing experience in the main display, such as minimize, maximize, close current windows, zoom in and out, etc. The “Text” mode key changes the PWAA application into the text entry mode. The “Password” key gives the user access to assigning and one-key entry of password and username for the applicable website. The “Site Controls” key provides the website owner's (or developer's) programmers, subject to a software developer kit and guidelines, the ability to download to the PWAA application's database and display as virtual keys/displays on the PWAA interface a set of keys that perform functionality that maximizes the user experience on the website, thereby allowing an integration of controls and functionality as between the website and the user interface. The “Add-ons” offers similar functionality as “Site Controls” except that functionality can be downloaded from third parties unrelated to the website owner/developer, analogously to third party add-ons to browsers, and may also be functionality added by the user to control the applicable website, such as macros that manipulate content or provide other functionality.

The software for the PWAA application contains rules and security functionality to check any third party access to and changes/downloads to the user interface's database. For instance, these rules prevent third parties from embedding content in the database that violates the underlying patterns of use of the three sets of keys of the PWAA application and its database structure.

The software database also contains fields for authorization codes that are issued by the entity controlling the PWAA application to third party developers for them to use to incorporate in their software and/or data field downloads to the PWAA database. The PWAA software checks for the authorization codes before allowing changes to be made, at least in the instance of database fields that have been assigned authorization codes.

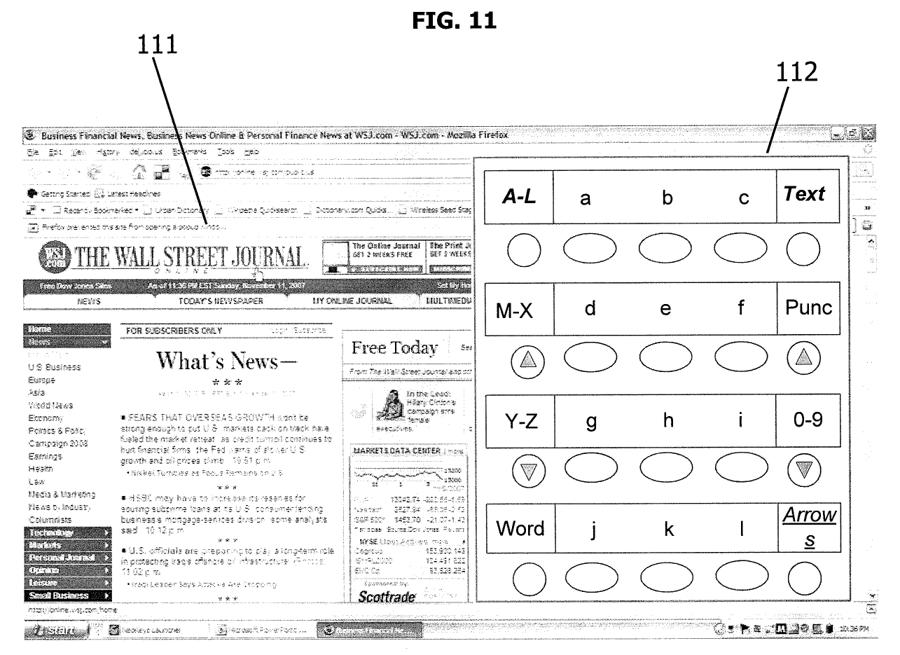

FIG. 11 illustratively depicts a screen capture of a PWAA interface 112 with embedded rules that change the mode of the PWAA application after the password mode into text mode with no action by the user. A website 111 has not been affected by this change in mode of the PWAA application; and, similarly, an application is also not be affected by a mode change in the PWAA application after launch of an application.

Alternative rules of sequencing after a URL launch key has been selected by the user from a website playlist can be implemented, such as described in the description for FIG. 11. Similarly, default rules for sequencing the PWAA application after launch of an application are set in the software on a per application basis, with the capability for the third party application developer to alter the sequencing to maximize the user interface/application integration for the user. This capability can also be implemented on a predictive basis, that can alter itself based on actual usage patterns by the user.

The database, as part of the rules enforcing the underlying structure in the context of also allowing for as much user and third party developer customization as possible, includes fields that indicate keys are “locked” meaning that their fields and attributes cannot be changed by third party developers or users.

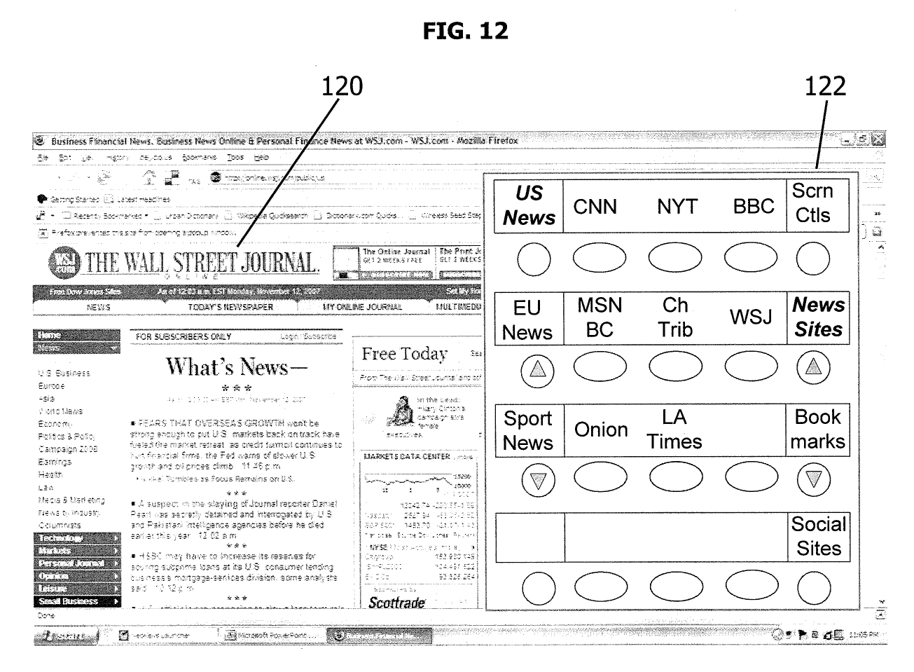

FIG. 12 illustratively depicts a screen capture of the PWAA application 122 when a virtual key that has been dedicated to the “back” functionality has been selected by the user, thereby changing the PWAA application from the text mode shown in FIG. 11 to the website playlist mode depicted in this FIG. 12. Again, the website 111 (and/or application) running has not been affected by this mode change in the PWAA application.

Although generally a mode change in the PWAA application based on the applicable rules/sequencing information in the PWAA application's database does not affect the state of a website or application, the database allows for the possibility that a specific mode change can affect the state of the website and/or application for the database fields for the applicable website/application that are programmable by third parties providing downloadable functionality specific to the website/application, subject to certain controls in the PWAA application software and database.

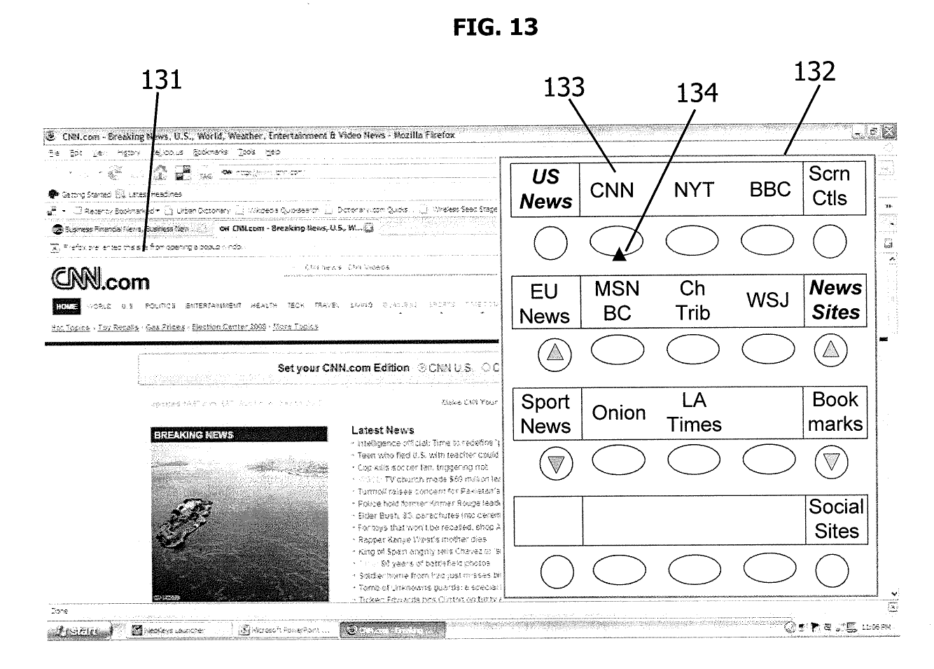

FIG. 13 illustratively depicts a screen capture of a browser window with a website page 113 as launched by a mouse click with a cursor 134 located on an applicable middle key 133 as a sequence from FIG. 12, demonstrating the PWAA application providing the user a means of launching websites within a website playlist by single presses on individual keys that reference into applicable URLs stored in the PWAA application's database in a hierarchical manner from bottom to top of middle twelve keys, then left hand keys, then right hand keys, then user. In this instance, the website playlist is an aggregation of news websites, with shorthand names (“CNN,” “NYT,” “BBC,” “MSNBC,” “CH Trib,” “WSJ,” “Onion,” and “LA Times”) of the websites shown on the virtual displays of the PWAA interface, which shorthand names are customizable by the user and stored in the database in a field associated with the key and a field associated with the field in the database in which the URL is stored, as well as fields indicating that this is set as a URL launch key, that this key is locked or unlocked and/or reserved for remote setting solely by a third party, and, a field for such reserved keys that provides either a link to the website of the third party where users can access archived settings for that key or one or more of the actual most recent settings for the key

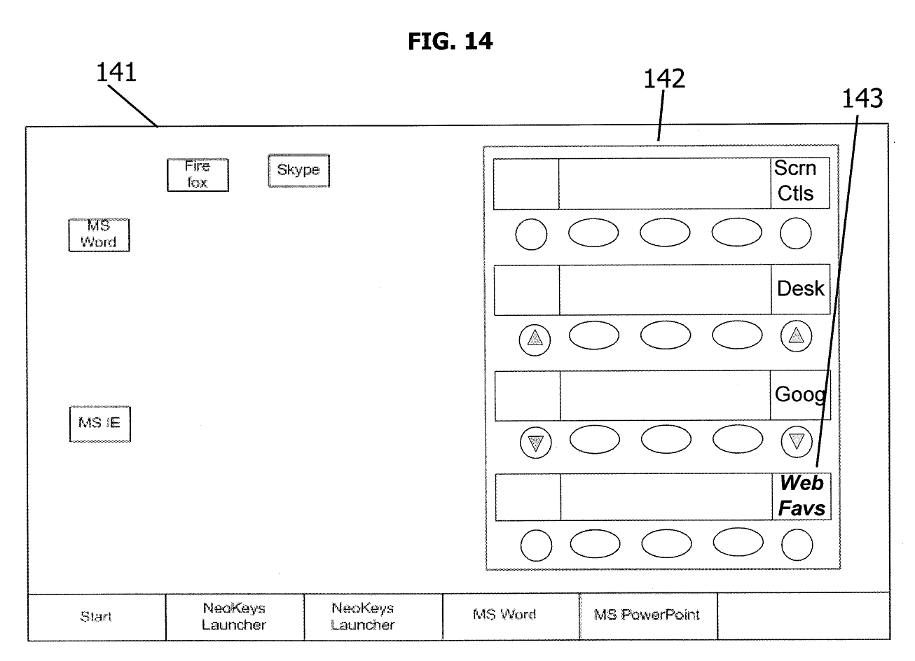

FIG. 14 illustratively depicts a screen capture of a standard desktop user interface 141 and a PWAA interface 142 with a right hand key 143 labeled “Web Favs” that has blank sets of middle keys and left hand keys. By pressing and holding (for a time period set in the PWAA application's database, in this instance a minimum of 0.5 seconds) one of the middle keys, the user is given the functionality to set or change the URL database launch fields (URL and shorthand label) for that virtual key/display.

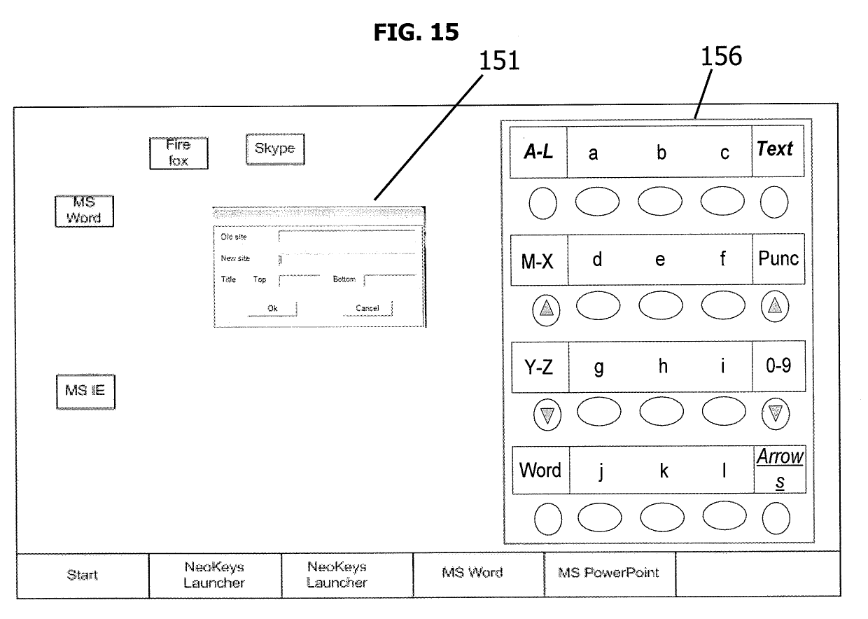

FIG. 15 illustratively depicts a screen capture of the next sequence established in the PWAA application software and database upon the pressing and holding of a URL launch key as described above for FIG. 14. The PWAA interface's sets of virtual keys/displays 156 have changed into text mode, and a PWAA-operated window 151 has opened wherein the user is prompted to enter a URL and a display label for the URL (in two lines for displaying in two lines in the virtual displays above the virtual keys of the PWAA interface). The window includes a box wherein the software displays the current URL field contents in the database. In this instance, that box is blank because the field is blank, meaning no URL had previously been assigned to that key/display in the database.

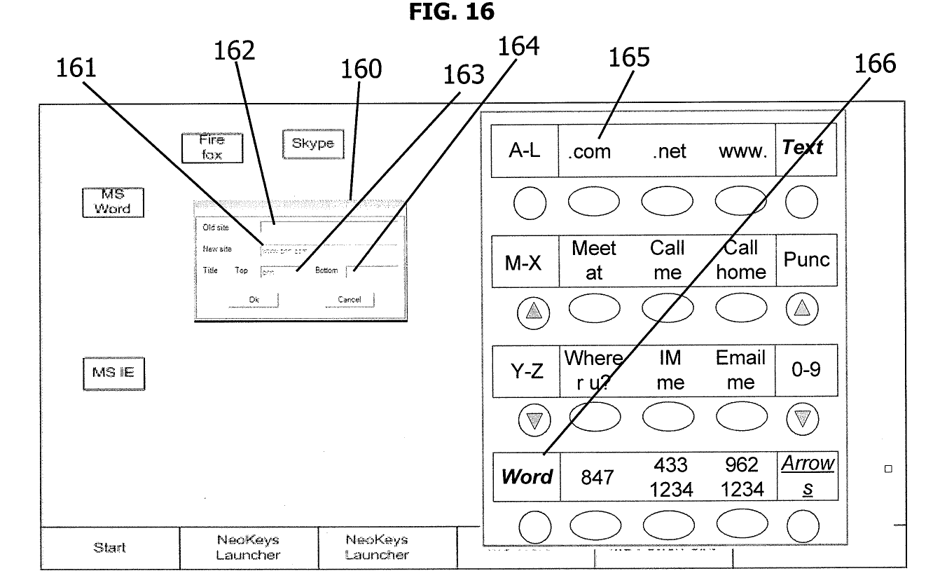

FIG. 16 illustratively depicts a screen capture of the data to be stored in the URL field prompt box 162 being set by a user. The user has entered a URL 161 to be stored in the URL field in the database once the user clicks on “OK” on the URL entry window 160 or enter, and the user has entered a label 163 for the virtual display field in the database for the top line of the virtual display area. The PWAA application is in text mode, and shows the user having selected the left hand key “Word” 166 in order to enter whole phrases using one key press in order to speed the entry of the URL, including, for instance, the phrase “.com” in the top left middle key 165.

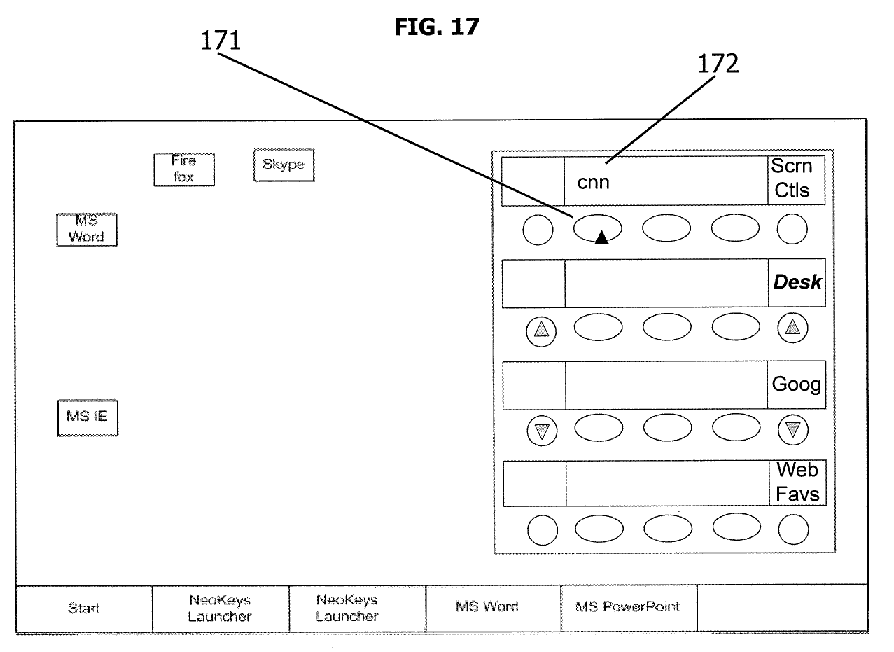

FIG. 17 illustratively depicts a screen capture of the PWAA interface after the user has selected “OK” (or enter) after completing the URL prompt box/window as depicted in FIG. 16 above, which, the PWAA software operates to both embed the entered data in the applicable fields in the PWAA database and to end text mode, and put the PWAA into website playlist mode with the sole URL allocated to this website playlist shown for the middle key virtual display 172 and its associated virtual key 171. The PWAA interface displays the label “cnn” that the user entered and stored in the database field using the URL prompt box functionality, as depicted in FIG. 16 above, in the virtual display 172 above the applicable virtual button 171.

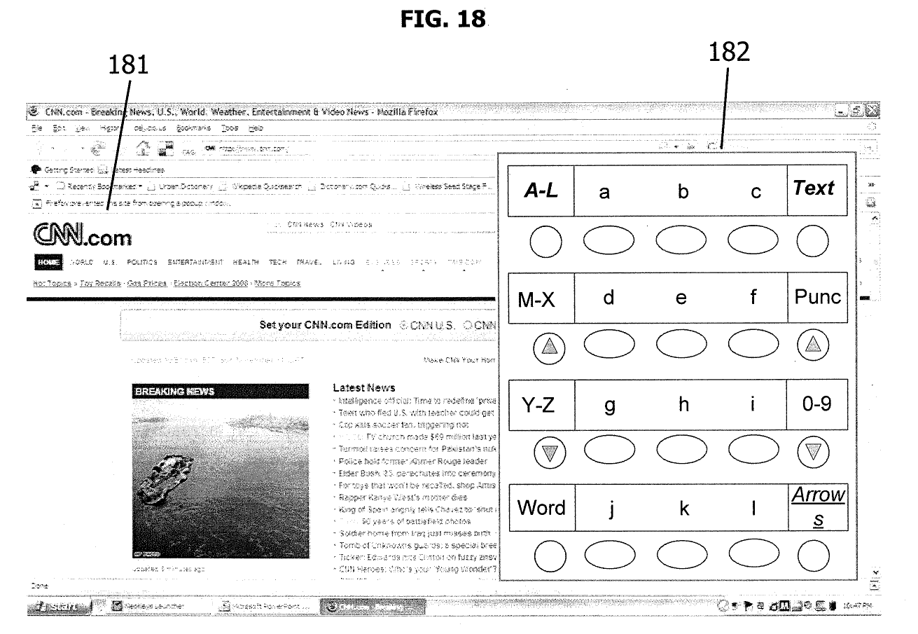

FIG. 18 illustratively depicts a screen capture of a browser showing a home page 181 of a website launched after the user has entered and stored a URL in the PWAA database as described in FIGS. 16 and 17 above and then has performed a click operation on the virtual key/display 171/172 of the skin image of the PWAA interface which contains the label chosen and entered by the user into the database to identify the URL. The PWAA application has (immediately upon the user's click on that the key/display) changed into text entry mode 182 in accordance with the sequencing instructions in the PWAA database applicable to that URL launch key.

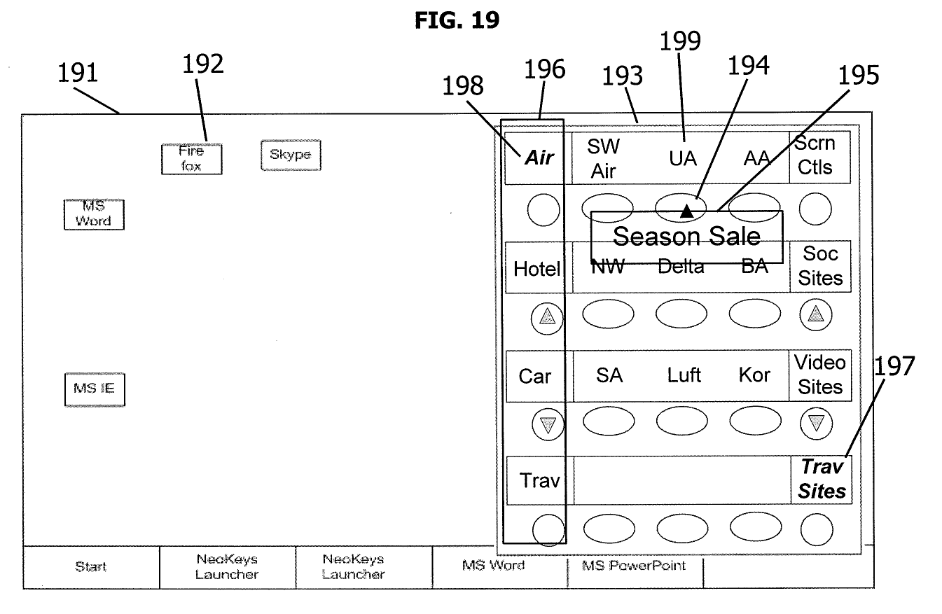

FIG. 19 illustratively depicts a screen capture of a standard desktop user interface 191 with a browser shortcut icon 192, as well as the PWAA interface in a mode selected among the right hand keys showing the active right hand at the bottom right as a key 197 highlighted (in this case with a bold font) and labeled “Travel Sites”. A set of left hand keys 196 have been set by the PWAA software according to the information fields in the PWAA application's database relevant to the selected right hand key 197, and a set of middle twelve keys 193 have been set by the PWAA software according to the information fields in the PWAA application's database relevant to the selected combination of right hand 197 and left hand 198 key. The screen capture also shows the cursor position indicator 194 (in this instance, represented by a black rectangle symbol) located over the virtual button associated with the virtual display showing the label “United”. In the database, this URL launch key's label field is populated with the text “United” (although the label field will display also be a graphic, for example, if the applicable data label field is flagged as containing a graphic image, and each label field has associated with it a field that indicates to the software code that fills the virtual display with the applicable label what format that label is stored in the applicable database field).

Further, an image 195 is superimposed by the PWAA software in relation to the virtual key/display over which the cursor is located that displays content fed on a dynamic downloable basis (or statically stored in the database for a period of time) from a content aggregator or from the URL company or another third party (as determined by a field in the database that directs the PWAA software as follows: (1) that there is content to be displayed when the cursor is over the virtual key/display area, (2) where to access that content, and (3) whom to notify that this content has been displayed to the user, as well as a database field to update indicating the numbers of times (and times and dates) the content has been viewed by the user. This super-imposed image provides the user with additional information as to the content accessible by launching the URL, and provides one or more entities controlling the content on the URL to give the user relevant and up-to-date information as to potentially interesting information about the content or functionality available on the URL. The content in the super-imposed image, in one alternative, is sourced and downloaded remotely on a dynamic basis, and consists of advertising content, as well as other information. The content in the super-imposed image optionally consists of text, graphics, audio, video or photos, animations or other single- or multi-media or a combination thereof, with the content type stored in the PWAA database, which type is used by the PWAA software to determine what information to display and at what times. The software for the PWAA application removes the super-imposed image when the user moves the cursor away from the area covered by the virtual key/display. Alternatively, this display information, or other enhanced display information, can be displayed in the virtual display area associated with the key, which, in this instance is the virtual display area where a word “United” 199 is depicted.

The software also stores and/or communicates to a remote server the super-imposed image/content display information, including, for instance, number of views, numeric (or other identifier) for the content, time duration the super-imposed image was shown to the user, whether the user pressed the applicable launch key to which the super-imposed image related within a certain period of time of the image having been displayed, etc. This permits the company controlling the PWAA application to charge (for instance, on an impression or click-through basis) for the super-imposed image, either directly to the URL owner or the content provider or to a third party, as well as to gather relevant information regarding the viewing of the super-imposed image, and to provide that information to third parties, subject to the applicable privacy policy and license agreement accepted by the user.

The PWAA software tracks (and stores in its database resident on the device and/or sends a report file to a remote server) a range of information that is assessed via certain algorithms to provide mapping information between the user's PWAA application usage patterns and delivery of impression-based content. The usage patterns include for instance, types and specific identities of websites aggregated into playlists by the user, website launches, dates and times of website launches (individually and in relation in time and in physical proximity (of virtual keys/displays) and database proximity among playlists), user customizations of website playlists. This information is tracked and assessed in order to provide content providers and users the most relevant impression-based marketing, advertising and other content shown to the user as the user moves the cursor (or other click system, such as fingertip or stylus) over and between and among the virtual displays/keys of the PWAA interface and the website and application playlists displayed thereon.

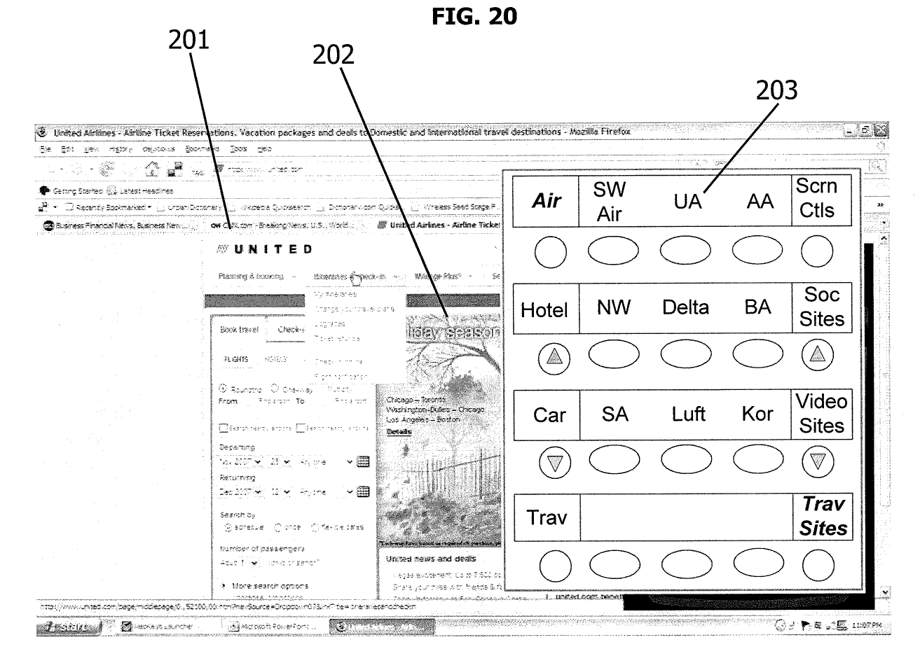

FIG. 20 illustratively depicts a screen capture of a website 201 as launched using the virtual key/display 193 described in FIG. 19 that had the super-imposed image displayed when the cursor was located by the user over the virtual key/display 203. The super-imposed image discussed in FIG. 19 contained a text cite (in this instance “Season Sale”) relevant to the website's current promotional content 202.

This functionality in the PWAA application provides an application with a user-customizable dedicated, direct URL launch key which application, based on flag being set in the PWAA database that indicates an ad impression is active for that key, displays an ad impression (or other content) in relation to the link in the database represented by a label for the link (which label can be pre-set, remotely set or user set, and stored in the field in the PWAA database relevant to the applicable virtual key/display. In other words, an application provides link and link/ad content functionality; and an application provides a link and dynamic summary information as to current content available on the linked URL.

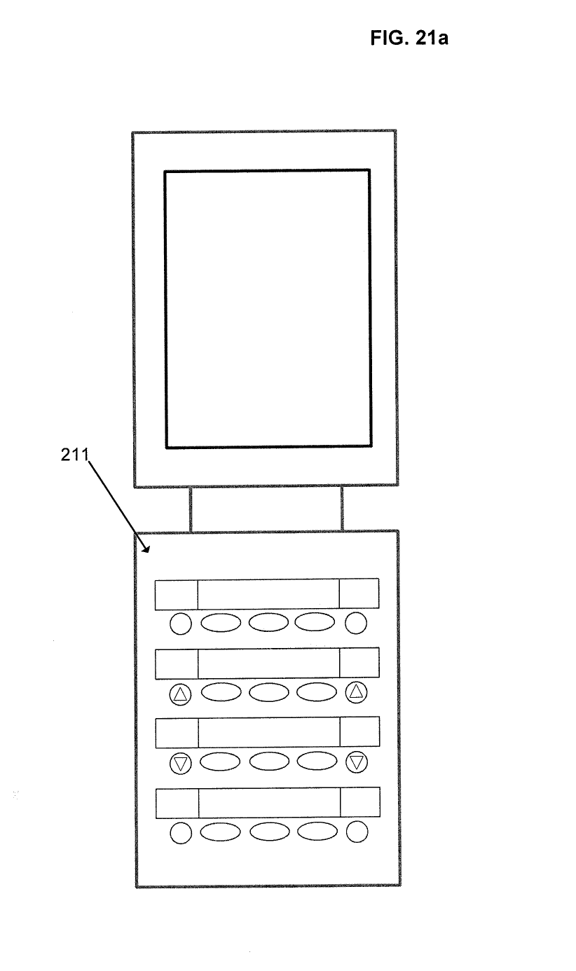

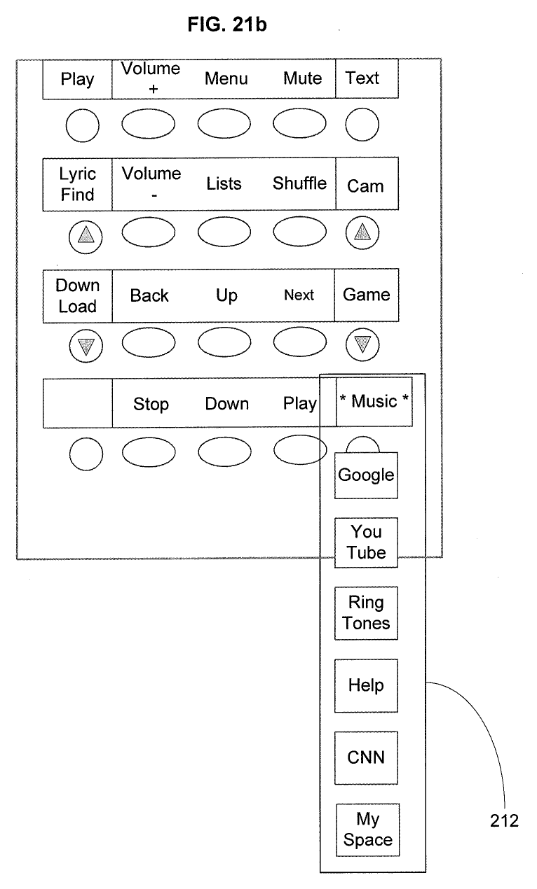

FIG. 21a illustratively depicts the scrolling of the right hand column of keys/displays, with an extended set of example display contents/key assignments for a right hand key array extending down 212 in the numerical order assigned them in the database fields as they will appear as the right hand column keys are scrolled down.

FIG. 21b illustratively depicts a physical key implementation of the PWAA in a mobile phone keypad 211.

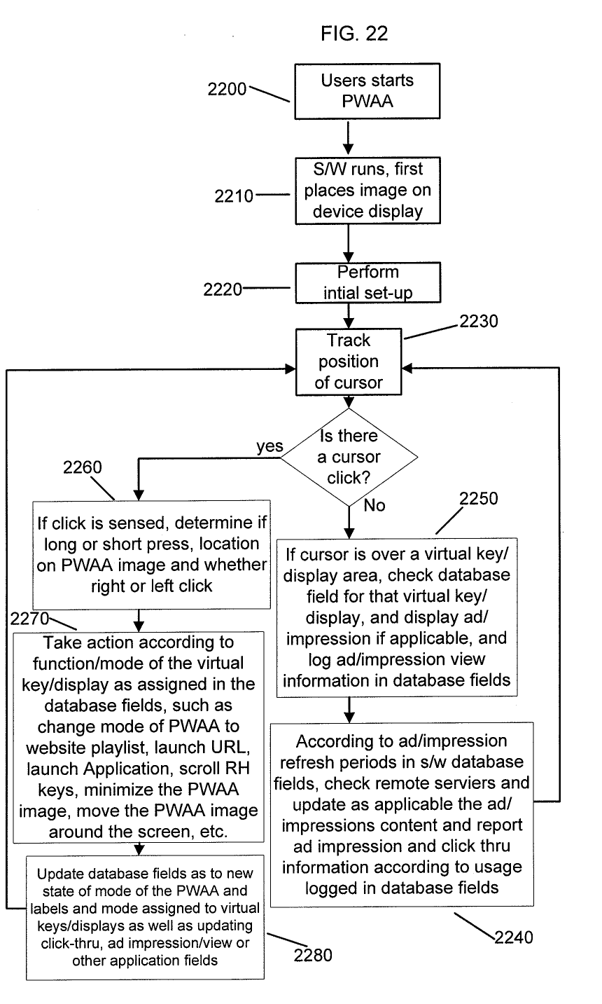

FIG. 22 illustratively depicts an exemplary flow chart for the software for the PWAA application, which summarizes a set of steps for the operation of the PWAA application. Step 2200 indicates that the software runs after it has been installed on a system when the user clicks on the icon for the PWAA application located on the desktop, or when the user clicks on the PWAA software name in the applicable application list menu on the system, or when the user clicks on the PWAA application add-on icon in a browser, or, alternatively, on system start-up, if the user has selected during the install process to have the PWAA application run when the system boots. Step 2210 indicates that the software initially places the skin image/graphical user interface on the display in an always-on-top window. Once the image is on the main display of the device, the software performs its initial set-up routine 2220, including that it accesses the default initial settings for the virtual keys/displays from the PWAA database, and populates the virtual displays with the applicable labels, as indicated in the applicable database fields, as well as, if applicable, indicating which user is logged in to the PWAA application. Further, as part of the initialization process, the software checks the ad impression (and other remote checks, such as for software or database field updates) information in the database for time and date for checking for updates from remote servers, and accesses the applicable remote servers if applicable.

During step 2230, the PWAA software tracks if and where the cursor is located over the image of the PWAA interface, and, if the cursor is located over the PWAA interface at certain locations, the PWAA application undertakes certain tasks, or, if the software determines there is a click operation indicated by the device operating system, the software undertakes 2260 to execute the applicable functionality of the PWAA application based on the location of the click occurrence, the length of the click, the current state of the PWAA application mode, and the information in the various database fields indexed into according to the current state of the PWAA application mode. For instance, in step 2260, the software identifies whether or not the click is held for a long enough time period to constitute a long-press on a virtual key, thereby activating a different action for at least some of the virtual keys as indicated in the PWAA database fields. In step 2270, the software undertakes the actions indicated by accessing the database fields and other information as specified above. In step 2280, the software updates the relevant database fields based on the actions undertaken in the preceding steps.

In all these instances, the location of the cursor may be controlled (and a click operation activated) by a mouse or by other cursor control means, such as directional pads, touch pads, directional keys, soft keys, stylus/pen systems and finger control surfaces. These controls are provided integrally with the PWAA application in its “arrow” and other control modes, but are implemented and available independent of the PWAA interface on devices.

In step 2250, when there is no cursor click, but the cursor is located over the PWAS image, the PWAA software operates the ad impression (or other information) viewing system of the PWAA application based on the location of the cursor, the current state of the PWAA application mode, and the information in the various database fields indexed into according to the current state of the PWAA application mode. In this viewing system operation, the PWAA application presents to the user as described in figures above, the applicable impression information in relation to cursor positioning over the image of the PWAA interface, the user patterns tracked and analyzed, and the information stored in the PWAA database and/or remotely retrieved.

In step 2240, the PWAA software operates the ad (or other information) retrieval and reporting system based on the relevant information in the PWAA database and the actions of the user in relation to the impression provided the user.

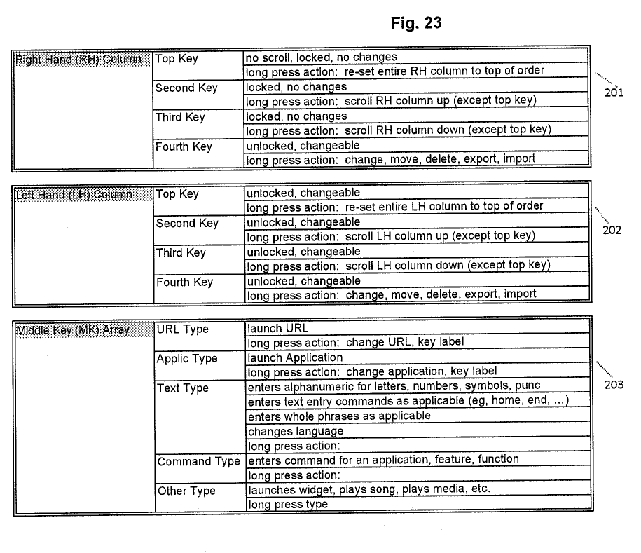

FIG. 23 illustratively depicts a set of rules for the software engine for the operation of the PWAA interface keys/displays in relation to the skin image and the database. These rules are developed in more detail in the software developer guidelines. At the core of these rules, there are the rules governing the operation of the right hand column keys/displays 201, the rules governing the operation of the left hand column keys/displays 202 and the rules governing the operation of the middle keys/displays 203. Some of these rules are encoded in the software, and others are controlled via information stored in fields in the database relevant to the applicable set of keys. These rules maintain a unified and predictable pattern of use for the PWAA application across all modes of its operation, including, in the context of user and third party customizations, updates, additions and deletions to the database fields.

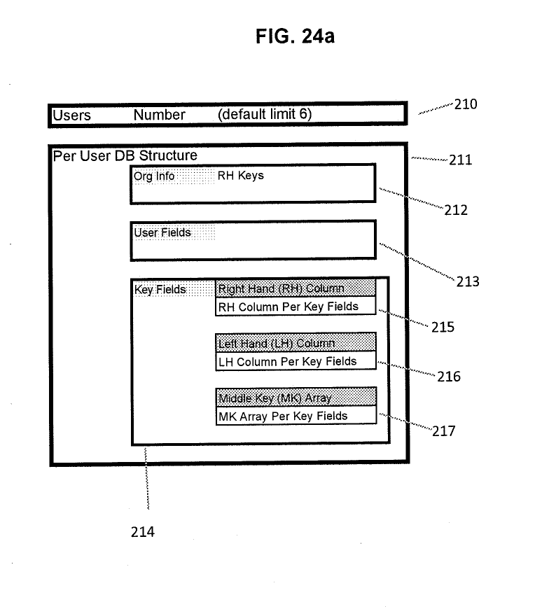

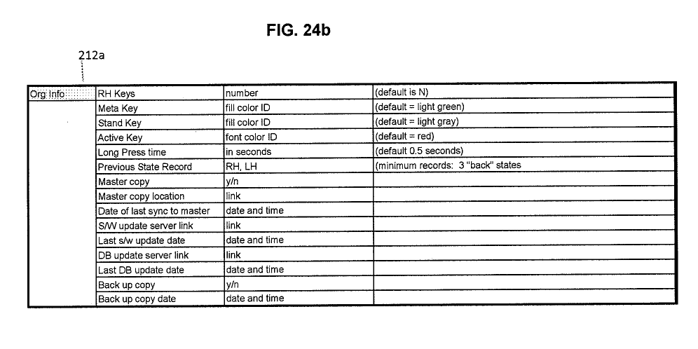

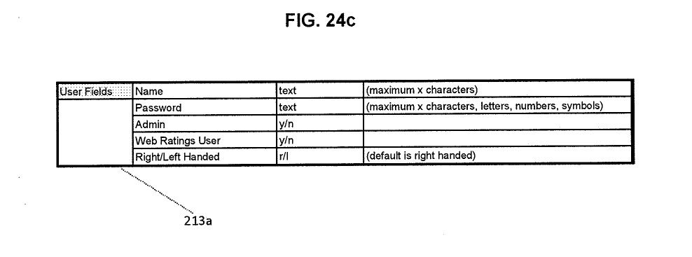

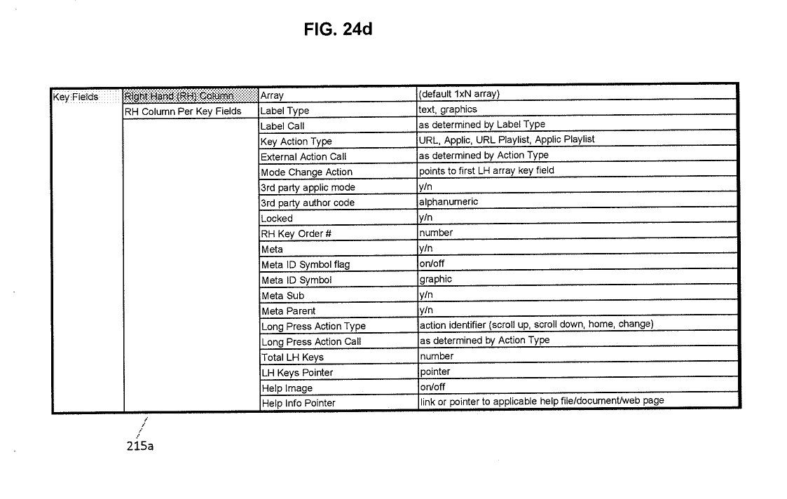

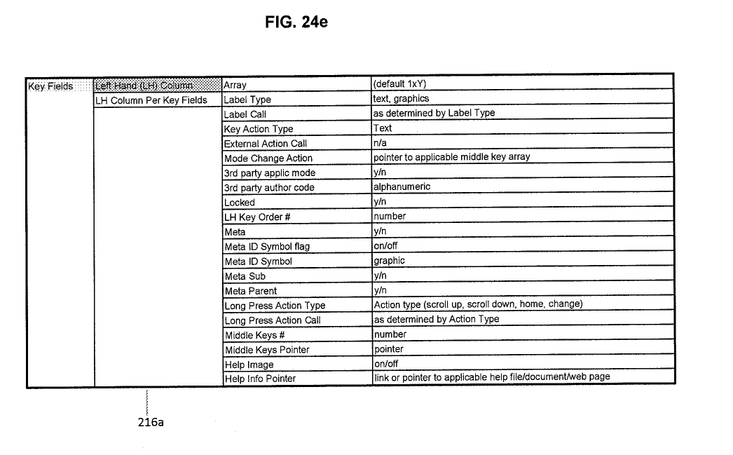

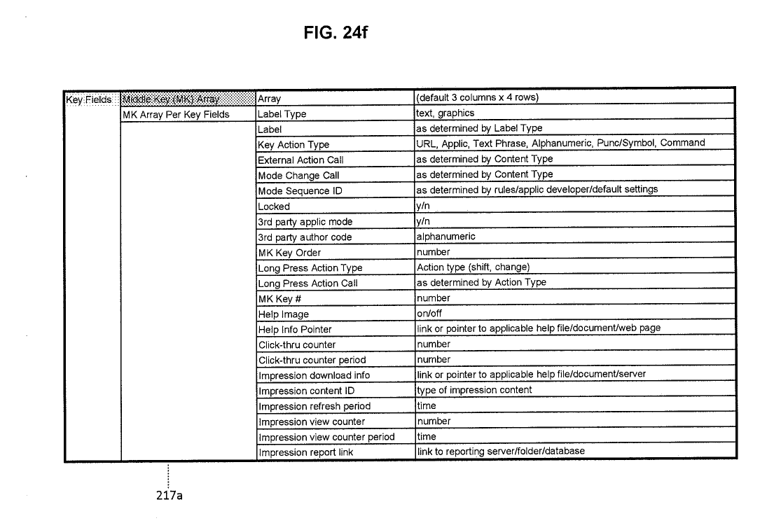

FIGS. 24a to 24f illustratively depict a database structure for the main components of the PWAA database. In FIG. 24a, in the context of a multi-user implementation of the PWAA application in which each user has a complete set of keys/displays and database settings, the first determining structure is the number of users 210, organization information for each user 211 and user identification fields 213. Within that construct for each user, the database is structured around a set of fields 214 organized according to the three sets of virtual keys/displays of the user-facing image of the PWAA application: right hand column keys/displays fields 215, left hand column keys/displays fields 216 and middle key/display fields 217. The fields within each group support the functionality described in the preceding figures, including, for instance fields identifying the numeric order of the keys in each key set, fields identifying the label to be displayed in association with the key, fields identifying the functionality of the key, fields identifying the sequence of modes applicable to activation of that key, meta key identifier fields, impression content information and links fields, etc. Each of the right hand, left hand and middle key fields have some fields in common and some differences, as determined in accordance with functionality, purpose and roles of the respective sets of keys in the operation of the PWAA application, and it underlying consistent and unifying patterns of use, consistent with the image and operation of the PWAA application visible to the user.

FIG. 24b illustratively depicts additional detail for the organization fields of the PWAA database that determine, among other items, the number of right hand keys in each user's implementation of the PWAA application, originally as set at install, and then as modified as the user personalizes or customizes the PWAA interface.

FIG. 24c illustratively depicts additional detail for fields in the PWAA database that define characteristics of the user. At the time of install, there is only one user, a default user, with a set of default characteristics. People using the PWAA application can add users by way of the user functionality in the PWAA application and can change the characteristics of the users. Changing the characteristics of the users modifies these fields in the PWAA application for the specific user.

FIG. 24d illustratively depicts additional detail for fields in the PWAA database that define characteristics of each right hand key in the PWAA interface for a user. For each right hand key, this includes a link to the set of left hand keys fields that are associated with a particular right hand key. A set of pre-packaged right hand, left hand and middle twelve key sets are included in the initial install of the PWAA application. Users can modify these in many ways using the PWAA application, subject to the software rules and database organizational and field structure. When modified, the changes are stored in the applicable PWAA database fields.

In other words, the PWAA application acts as a tool for a user to see and access data from the PWAA fields, a tool to modify the data in the PWAA database fields and a tool to take actions based on the content in the PWAA database fields. In all these instances, the pattern of use of the three sets of PWAA interface keys (scroll and selection of right hand keys determines left hand keys which in turn determines middle twelve keys) is the same.

FIG. 24e illustratively depicts additional detail for the master set of fields in the PWAA database that define characteristics of left hand keys.

FIG. 24f illustratively depicts additional detail for the master set of fields in the PWAA database that define characteristics of middle keys.

In each instance of the illustrated set of fields, additional, new or different fields are implemented to add functionality to the PWAA interface, always subject to the underlying software rules and the underlying structure and method or pattern of use of the three sets of keys of the PWAA interface.

A computing device and associated software/hardware/firmware components and/or methods have been described herein above with reference to exemplary embodiments of the invention including their structures and techniques, It is noted that the present invention is implemented in computer hardware, firmware, and software in the form of computer-readable media including computer-executable instructions for carrying out the described functionality/methodology. In view of the many possible embodiments to which the principles of this invention may be applied, it should be recognized that the embodiments described herein with respect to the drawing figures are meant to be illustrative only and should not be taken as limiting the scope of invention. Therefore, the invention as described herein contemplates all such embodiments as may come within the scope of the following claims and equivalents thereof.

What is claimed is:

1. A computing device providing access to a variety of applications and resources, the computing device including:
a display;
a computer-readable medium comprising computer-executable instructions for a personal Web and application assistant (PWAA) program, the PWAA program being executable on the computing device to:
provide a PWAA interface on the display, wherein the PWAA interface provides button controls and associated programmable displays for
(1) organizing, accessing and using application programs on the computing device, and
(2) organizing, accessing and using websites,
wherein the application programs and websites are organized on the PWAA interface by categories selectable by: first selecting from a first set of virtual keys associated with a highest level of organization of applications programs and websites, second selecting from a second set of virtual keys to assign particular programmed instructions to individual launch keys in a third set of virtual keys.

2. The computing device of claim 1 wherein the PWAA interface further comprises a text entry mode offering full QWERTY keyboard alphanumeric character coverage.

3. The computing device of claim 1 wherein the PWAA interface further comprises a musical notes entry mode.

4. The computing device of claim 1 wherein the display is embedded in a mobile phone.

5. The computing device of claim 1 wherein the PWAA interface occupies less than half a full screen area of the display.

6. The computing device of claim 1 wherein the PWAA interface is displayed on top of any window image of applications and websites shown on the display.

7. The computing device of claim 6 wherein the PWAA interface is moveable and resizable by a user, and the PWAA interface includes pop-out tabs that are displayed when the user relocates the PWAA interface substantially off a display area of the display, whereby the tabs are used to grab and move the WPAA interface back onto the screen area.

8. The computing device of claim 1 wherein the PWAA interface is changeable by a user using a mode control set of keys and displays accessed within the PWAA interface.

9. The computing device of claim 1 wherein the PWAA interface displays advertisements above or in a region near, as part of a label of, keys labeled to a specific brand and URL or application associated with the brand or URL or application when the user moves a cursor over the keys, and then, as the cursor is moved away from the keys, the advertisement is removed from the display.

10. The computing device of claim 9 wherein the advertisement is one or a combination of a static image, a video or dynamic image and an audio file.

11. The computing device of claim 9 wherein the advertisements are stored in database fields of the WPAA program for a pre-set period of time.

12. The computing device of claim 9 wherein the advertisements are dynamically generated on remote servers, links to which are stored in fields of a user interface database in relation to the fields for the applicable key in the third set of keys of the user interface.

13. The computing device of claim 9 wherein a click on a key for which an advertisement is currently being display generates an electronic message to a remote accounting server for reporting and/or billing purposes to an entity related to a brand associated with the key.

14. The computing device of claim 1 wherein each virtual display contains a help icon that links in database fields for the display to user-oriented help information for the specific key.

15. The computing device of claim 1 wherein each virtual key contains a help icon that links in the database fields for displaying user-oriented help information for the corresponding one of the virtual key.

16. The computing device of claim 1 wherein cursor movements and clicks on the user interface image are tracked and assessed using algorithms in relation to database fields of the user interface containing URL identifiers and in relation to physical locations of the virtual keys and displays of the PWAA interface in order to deliver impression-based advertising, marketing and other content to the user dynamically and relevantly to the data tracked and results of the assessments.
